(19) United States
(12) Patent Application Publication
(10) Pub. No.: US 2009/0179995 A1
(43) Pub. Date: Jul. 16, 2009

(54) Image Shooting Apparatus and Blur Correction Method

(75) Inventors: Shimpei FUKUMOTO, Osaka (JP); Haruo HATANAKA, Kyoto City (JP); Yukio MORI, Osaka (JP); Haruhiko MURATA, Osaka (JP)

Correspondence Address: NDQ&M WATCHSTONE LLP, 1300 EYE STREET, NW, SUITE 1000 WEST TOWER, WASHINGTON, DC, 20005, US

(73) Assignee: SANYO ELECTRIC CO., LTD., Osaka (JP)

(21) Appl. No.: 12/353,430

(22) Filed: Jan. 14, 2009

(30) Foreign Application Priority Data
Jan. 16, 2008 (JP) 2008-007169
Feb. 1, 2008 (JP) 2008-023075
Dec. 1, 2008 (JP) 2008-306307

(51) Int. Cl. H04N 5/228

(52) U.S. Cl. 348/208.6; 348/E05.031

(57) ABSTRACT

An image shooting apparatus includes: an image-sensing portion adapted to acquire an image by shooting; a blur correction processing portion adapted to correct blur in a first image obtained by shooting based on the first image and a second image shot with an exposure time shorter than the exposure time of the first image; and a control portion adapted to control whether or not to make the blur correction processing portion execute blur correction processing.

This nonprovisional application claims priority under 35 U.S.C. §119(a) on Patent Application No. 2008-007169 filed in Japan on Jan. 16, 2008, Patent Application No. 2008-023075 filed in Japan on Feb. 1, 2008, and Patent Application No. 2008-306307 filed in Japan on Dec. 1, 2008, the entire contents of which are hereby incorporated by reference.

### BACKGROUND OF THE INVENTION

1. Field of the Invention

The present invention relates to an image shooting apparatus, such as a digital still camera, furnished with a function for correcting blur in an image. The invention also relates to a blur correction method for achieving such a function.

2. Description of Related Art

A motion blur correction technology is for reducing motion blur occurring during image shooting, and is highly valued as a differentiating technology in image shooting apparatuses such as digital still cameras.

Among conventionally proposed motion blur correction methods are some that employ a consulted image (in other words, reference image) shot with a short exposure time. According to such a method, while a correction target image is shot with a proper exposure time, a consulted image is shot with an exposure time shorter than the proper exposure time and, by the use of the consulted image, blur in the correction target image is corrected.

Since blur in the consulted image shot with a short exposure time is relatively small, by use of the consulted image, it is possible to estimate or otherwise deal with the blur condition of the correction target image. Once the blur condition of the correction target image is estimated, it is then possible to reduce the blur in the correction target image by image restoration (deconvolution) processing or the like.

There has been proposed image restoration processing employing Fourier iteration. FIG. 37 is a block diagram showing a configuration for achieving Fourier iteration. In Fourier iteration, through iterative execution of Fourier and inverse Fourier transforms by way of revision of a restored (deconvolved) image and a point spread function (PSF), the definitive restored image is estimated from a degraded (convolved) image. To execute Fourier iteration, an initial restored image (the initial value of a restored image) needs to be given. Typically used as the initial restored image is a random image, or a degraded image as a motion blur image.

Motion blur correction methods based on image processing employing a consulted image do not require a motion blur sensor (physical vibration sensor) such as an angular velocity sensor, and thus greatly contribute to cost reduction of image shooting apparatuses;

However, in view of how image shooting apparatuses are used in practice, such methods employing a consulted image leave room for further improvement.

### SUMMARY OF THE INVENTION

A first image shooting apparatus according to the present invention is provided with: an image-sensing portion adapted to acquire an image by shooting; a blur correction processing portion adapted to correct blur in a first image obtained by shooting based on the first image and a second image shot with an exposure time shorter than the exposure time of the first image; and a control portion adapted to control whether or not to make the blur correction processing portion execute blur correction processing.

Specifically, for example, the control portion is provided with a blur estimation portion adapted to estimate the degree of blur in the second image, and controls, based on the result of the estimation by the blur estimation portion, whether or not to make the blur correction processing portion execute blur correction processing.

More specifically, for example, the blur estimation portion estimates the degree of blur in the second image based on the result of comparison between the edge intensity of the first image and the edge intensity of the second image.

For example, sensitivity for adjusting the brightness of a shot image differs between during the shooting of the first image and during the shooting of the second image, and the blur estimation portion executes the comparison through processing that involves reducing the difference in edge intensity between the first and second images resulting from the difference in sensitivity between during the shooting of the first image and during the shooting of the second image.

Instead, for example, the blur estimation portion estimates the degree of blur in the second image based on the amount of displacement between the first and second images.

Instead, for another example, the blur estimation portion estimates the degree of blur in the second image based on an estimated image degradation function of the first image as found by use of the first and second images.

For example, the blur estimation portion refers to the values of the individual elements of the estimated image degradation function as expressed in the form of a matrix, then extracts, out of the values thus referred to, those values which fall outside a prescribed value range, and then estimates the degree of blur in the second image based on the sum value of the values thus extracted.

A second image shooting apparatus according to the present invention is provided with: an image-sensing portion adapted to acquire an image by shooting; a blur correction processing portion adapted to correct blur in a first image obtained by shooting based on the first image and one or more second images shot with an exposure time shorter than the exposure time of the first image; and a control portion adapted to control, based on a shooting parameter of the first image, whether or not to make the blur correction processing portion execute blur correction processing or the number of second images to be used in blur correction processing.

Specifically, for example, the control portion comprises: a second-image shooting control portion adapted to judge whether or not it is practicable to shoot the second image based on the shooting parameter of the first image and control the image-sensing portion accordingly; and a correction control portion adapted to control, according to the result of the judgment of whether or not it is practicable to shoot the second image, whether or not to make the blur correction processing portion execute blur correction processing.

Instead, for example, the control portion comprises a second-image shooting control portion adapted to determine, based on the shooting parameter of the first image, the number of second images to be used in blur correction processing by the blur correction processing portion and control the image-sensing portion so as to shoot the thus determined number of second images; the second-image shooting control portion determines the number of second images to be one or plural; and when the number of second images is plural, the blur correction processing portion additively merges together the plural number of second images to generate one merged image, and corrects blur in the first image based on the first image and the merged image.

Specifically, for example, the shooting parameter of the first image includes focal length, exposure time, and sensitivity for adjusting the brightness of an image during the shooting of the first image.

Specifically, for example, the second-image shooting control portion sets a shooting parameter of the second image based on the shooting parameter of the first image.

Specifically, for example, the blur correction processing portion handles an image based on the first image as a degraded image and an image based on the second image as an initial restored image, and corrects blur in the first image by use of Fourier iteration.

Specifically, for example, the blur correction processing portion comprises an image degradation function derivation portion adapted to find an image degradation function representing blur in the entire first image, and corrects blur in the first image based on the image degradation function; and the image degradation function derivation portion definitively finds the image degradation function through processing involving: preliminarily finding the image degradation function in a frequency domain from a first function obtained by converting an image based on the first image into a frequency domain and a second function obtained by converting an image based on the second image into a frequency domain; and revising, by use of a predetermined restricting condition, a function obtained by converting the thus found image degradation function in a frequency domain into a spatial domain.

Instead, for example, the blur correction processing portion merges together the first image, the second image, and a third image obtained by reducing noise in the second image, to thereby generate a blur-corrected image in which blur in the first image has been corrected.

More specifically, for example, the blur correction processing portion first merges together the first and third images to generate a fourth image, and then merges together the second and fourth images to generate the blur-corrected image.

Still more specifically, for example, the merging ratio at which the first and third images are merged together is set based on the difference between the first and third images, and the merging ratio at which the second and fourth images are merged together is set based on an edge contained in the third image.

A first blur correction method according to the present invention is provided with: a blur correction processing step of correcting blur in a first image obtained by shooting based on the first image and one or more second images shot with an exposure time shorter than the exposure time of the first image; and a controlling step of controlling whether or not to make the blur correction processing step execute blur correction processing.

For example, the controlling step comprises a blur estimation step of estimating the degree of blur in the second image so that, based on the result of the estimation, whether or not to make the blur correction processing step execute blur correction processing is controlled.

A second blur correction method according to the present invention is provided with: a blur correction processing step of correcting blur in a first image obtained by shooting based on the first image and one or more second images shot with an exposure time shorter than the exposure time of the first image; and a controlling step of controlling, based on a shooting parameter of the first image, whether or not to make the blur correction processing step execute blur correction processing or the number of second images to be used in blur correction processing.

The significance and benefits of the invention will be clear from the following description of its embodiments. It should however be understood that these embodiments are merely examples of how the invention is implemented, and that the meanings of the terms used to describe the invention and its features are not limited to the specific ones in which they are used in the description of the embodiments.

### BRIEF DESCRIPTION OF THE DRAWINGS

FIG. 1 is an overall block diagram of an image shooting apparatus embodying the invention;

FIG. 2 is an internal block diagram of the image-sensing portion in FIG. 1;

FIG. 3 is an internal block diagram of the main control portion in FIG. 1;

FIG. 4 is a flow chart showing the operation for shooting and for correction in an image shooting apparatus according to a first embodiment of the invention;

FIG. 5 is a flow chart showing the operation for judging whether or not to shoot a short-exposure image and for setting shooting parameters in connection with the first embodiment of the invention;

FIG. 6 is a graph showing the relationship between focal length and motion blur limit exposure time;

FIG. 7 is a flow chart showing the operation for shooting and for correction in an image shooting apparatus according to a second embodiment of the invention;

FIG. 8 is a flow chart showing the operation for shooting and for correction in an image shooting apparatus according to a third embodiment of the invention;

FIG. 9 is a flow chart showing the operation for estimating the degree of blur of a short-exposure image in connection with the third embodiment of the invention;

FIG. 10 is a diagram showing the pixel arrangement of an evaluated image extracted from an ordinary-exposure image or short-exposure image in connection with the third embodiment of the invention;

FIG. 11 is a diagram showing the arrangement of luminance values in the evaluated image shown in FIG. 10;

FIG. 12 is a diagram showing a horizontal-direction secondary differentiation filter usable in calculation of an edge intensity value in connection with the third embodiment of the invention;

FIG. 13 is a diagram showing a vertical-direction secondary differentiation filter usable in calculation of an edge intensity value in connection with the third embodiment of the invention;

FIG. 14A is a diagram showing luminance value distributions in images that are affected and not affected, respectively, by noise in connection with the third embodiment of the invention;

FIG. 14B is a diagram showing edge intensity value distributions in images that are affected and not affected, respectively, by noise in connection with the third embodiment of the invention;

FIGS. 15A, 15B, and 15C are diagrams showing an ordinary-exposure image containing horizontal-direction blur, a short-exposure image containing no horizontal- or vertical-direction blur, and a short-exposure image containing vertical-direction blur, respectively, in connection with the third embodiment of the invention;

FIGS. 16A and 16B are diagrams showing the appearance of the amounts of motion blur in cases where the amount of displacement between an ordinary-exposure image and a short-exposure image is small and large, respectively, in connection with the third embodiment of the invention;

FIG. 17 is a diagram illustrating the relationship among the pixel value distributions of an ordinary-exposure image and a short-exposure image and the estimated image degradation function (h₁′) of the ordinary-exposure image in connection with the third embodiment of the invention;

FIG. 18 is a flow chart showing the flow of blur correction processing according to a first correction method in connection with a fourth embodiment of the invention;

FIG. 19 is a detailed flow chart of the Fourier iteration executed in blur correction processing by the first correction method in connection with the fourth embodiment of the invention;

FIG. 20 is a block diagram showing the configuration for achieving the Fourier iteration shown in FIG. 19

FIG. 21 is a flow chart showing the flow of blur correction processing according to a second correction method in connection with the fourth embodiment of the invention;

FIG. 22 is a conceptual diagram of blur correction processing corresponding to FIG. 21;

FIG. 23 is a flow chart showing the flow of blur correction processing according to a third correction method in connection with the fourth embodiment of the invention;

FIG. 24 is a conceptual diagram of blur correction processing corresponding to FIG. 23;

FIG. 25 is a diagram showing a one-dimensional Gaussian distribution in connection with the fourth embodiment of the invention;

FIG. 26 is a diagram illustrating the effect of blur correction processing corresponding to FIG. 23;

FIGS. 27A and 27B are diagrams showing an example of a consulted image and a correction target image, respectively, taken up in the description of a fourth correction method in connection with the fourth embodiment of the invention;

FIG. 28 is a diagram showing a two-dimensional coordinate system and a two-dimensional image in a spatial domain;

FIG. 29 is an internal block diagram of the image merging portion used in the fourth correction method in connection with the fourth embodiment of the invention;

FIG. 30 is a diagram showing a second intermediary image obtained by reducing noise in the consulted image shown in FIG. 27A;

FIG. 31 is a diagram showing a differential image between a correction target image after position adjustment (a first intermediary image) and a consulted image after noise reduction processing (a second intermediary image);

FIG. 32 is a diagram showing the relationship between the differential value obtained by the differential value calculation portion shown in FIG. 29 and the mixing factor between the pixel signals of first and second intermediary images;

FIG. 33 is a diagram showing a third intermediary image obtained by merging together a correction target image after position adjustment (a first intermediary image) and a consulted image after noise reduction processing (a second intermediary image);

FIG. 34 is a diagram showing an edge image obtained by applying edge extraction processing to a consulted image after noise reduction processing (a second intermediary image);

FIG. 35 is a diagram showing the relationship between the edge intensity value obtained by the edge intensity value calculation portion shown in FIG. 29 and the mixing factor between the pixels signals of a consulted image and a third intermediary image;

FIG. 36 is a diagram showing a blur-corrected image obtained by merging together a consulted image and a third intermediary image; and

FIG. 37 is a block diagram showing a conventional configuration for achieving Fourier iteration.

### DETAILED DESCRIPTION OF PREFERRED EMBODIMENTS

Hereinafter, embodiments of the present invention will be described specifically with reference to the accompanying drawings. Among the different drawings referred to in the course, the same parts are identified by common reference signs, and in principle no overlapping description of the same parts will be repeated. Before the description of a first to a fourth embodiment given later, first the features common to or referred to in connection with all those embodiments will be described.

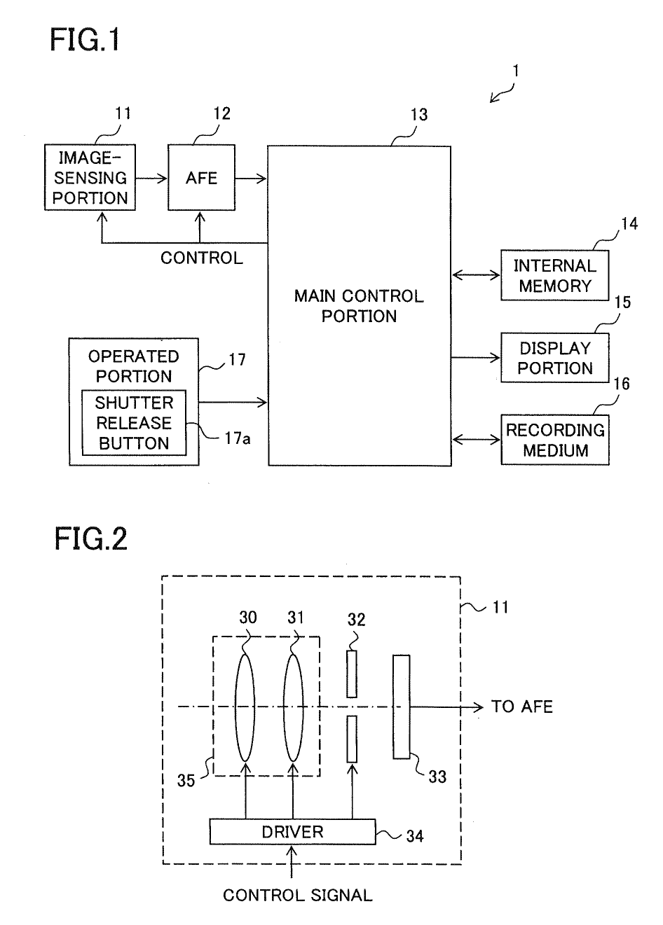

FIG. 1 is an overall block diagram of an image shooting apparatus 1 embodying the invention. The image shooting apparatus 1 is a digital still camera capable of shooting and recording still images, or a digital video camera capable of shooting and recording still and moving images.

The image shooting apparatus 1 is provided with an image-sensing portion 1, an AFE (analog front-end) 12, a main control portion 13, an internal memory 14, a display portion 15, a recording medium 16, and an operated portion 17. The operated portion 17 is provided with a shutter release button 17a.

FIG. 2 is an internal block diagram of the image-sensing portion 11. The image-sensing portion 11 has an optical system 35, an aperture stop 32, an image sensor 33 composed of a CCD (charge-coupled device) or CMOS (complementary metal oxide semiconductor) image sensor or the like, and a driver 34 for driving and controlling the optical system 35 and the aperture stop 32. The optical system 35 is composed of a plurality of lenses including a zoom lens 30 and a focus lens 31. The zoom lens 30 and the focus lens 31 are movable along the optical axis. Based on a control signal from the main control portion 13, the driver 34 drives and controls the positions of the zoom lens 30 and the focus lens 31 and the degree of aperture of the aperture stop 32, so as to thereby control the focal length (angle of view) and focal position of the image-sensing portion 11 and the amount of light incident on the image sensor 33.

An optical image representing a subject is incident, through the optical system 35 and the aperture stop 32, on the image sensor 33, which photoelectrically converts the optical image to output the resulting electrical signal to the AFE 12. More specifically, the image sensor 33 is provided with a plurality of light-receiving pixels arrayed in a two-dimensional matrix, and these light-receiving pixels each accumulate, in every shooting period, signal electric charge of which the amount is commensurate with the exposure time. Each light-receiving pixel outputs an analog signal having a level proportional to the amount of electric charge accumulated as signal electric charge there, and the analog signal from one pixel after another is outputted sequentially to the AFE 12 in synchronism with drive pulses generated within the image shooting apparatus 1. In the following description, “exposure” denotes the exposure of the image sensor 33 to light. The length of the exposure time is controlled by the main control portion 13. The AFE 12 amplifies the analog signal outputted from the image-sensing portion 11 (image sensor 33), and converts the amplified analog signal into a digital signal. The AFE 12 outputs one such digital signal after another sequentially to the main control portion 13. The amplification factor in the AFE 12 is controlled by the main control portion 13.

The main control portion 13 is provided with a CPU (central processing unit), a ROM (read only memory), a RAM (random access memory), etc., and functions as a video signal processing portion. Based on the output signal of the AFE 12, the main control portion 13 generates a video signal representing the image shot by the image-sensing portion 11 (hereinafter also referred to as the “shot image”). The main control portion 13 also functions as a display control portion for controlling what is displayed on the display portion 15, and controls the display portion 15 to achieve display as desired.

The internal memory 14 is formed of SDRAM (synchronous dynamic random access memory) or the like, and temporarily stores various kinds of data generated within the image shooting apparatus 1. The display portion 15 is a display device composed of a liquid crystal display panel or the like, and under the control of the main control portion 13 displays a shot image, an image recorded in the recording medium 16, or the like. The recording medium 16 is a non-volatile memory such as an SD (Secure Digital) memory card, and under the control of the main control portion 13 stores a shot image or the like.

The operated portion 17 accepts operation from outside. How the operated portion 17 is operated is transmitted to the main control portion 13. The shutter release button 17a is for requesting shooting and recording of a still image. When the shutter release button 17a is pressed, shooting and recording of a still image is requested.

The shutter release button 17a can be pressed in two steps: when a photographer presses the shutter release button 17a lightly, it is brought into a halfway pressed state; when from this state the photographer presses the shutter release button 17a further in, it is brought into a fully pressed state.

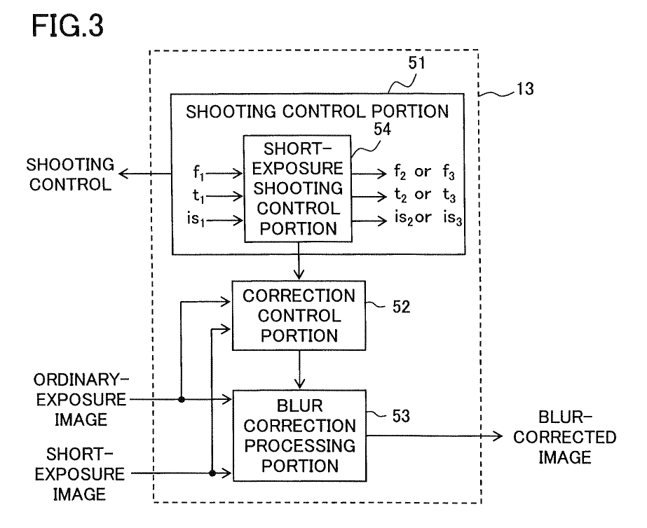

A still image as a shot image can contain blur due to motion such as camera shake. The main control portion 13 is furnished with a function for correcting such blur in a still image by image processing. FIG. 3 is an internal block diagram of the main control portion 13, showing only its portions involved in blur correction. As shown in FIG. 3, the main control portion 13 is provided with a shooting control portion 51, a correction control portion 52, and a blur correction processing portion 53.

Based on an ordinary-exposure image obtained by ordinary-exposure shooting and a short-exposure image obtained by short-exposure shooting, the blur correction processing portion 53 corrects blur in the ordinary-exposure image. Ordinary-exposure shooting denotes shooting performed with a proper exposure time, and short-exposure shooting denotes shooting performed with an exposure time shorter than the proper exposure time. An ordinary-exposure image is a shot image (still image) obtained by ordinary-exposure shooting, and a short-exposure image is a shot image (still image) obtained by short-exposure shooting. The processing executed by the blur correction processing portion 53 to correct blur is called blur correction processing. The shooting control portion 51 is provided with a short-exposure shooting control portion 54 for controlling shooting for short-exposure shooting. For short-exposure shooting, shooting is controlled in terms of, among others, the focal length, the exposure time, and the ISO sensitivity during short-exposure shooting. The significances of the symbols (f₁ etc.) shown in FIG. 3 will be clarified later in the course of description.

Although a short-exposure image shot with a short exposure time is expected to contain a small degree of blur, in reality, depending on the shooting skill of the photographer and other factors, a short-exposure image may contain a non-negligible degree of blur. To obtain a sufficient blur correction effect, it is necessary to use a short-exposure image with no or a small degree of blur. In actual shooting, however, it may be impossible to shoot such a short-exposure image. Moreover, exactly because of the short exposure time, a short-exposure image necessarily has a relatively low signal-to-noise ratio. To obtain a sufficient blur correction effect, it is necessary to give a short-exposure image an adequately high signal-to-noise ratio. In actual shooting, however, it may be impossible to shoot such a short-exposure image. If blur correction processing is performed by use of a short-exposure image containing a large degree of blur or a short-exposure image with a small signal-to-noise ratio, it is difficult to obtain a satisfactory blur correction effect, and, on the contrary, even a corrupted image may be generated. Obviously it is better to avoid executing blur correction processing that produces hardly any correction effect or executing blur correction processing that generates a corrupted image. The image shooting apparatus 1 operates with these circumstances taken into consideration.

Presented below as embodiments by way of which to describe the operation of the image shooting apparatus 1, including the detailed operation of the individual blocks shown in FIG. 3, will be four embodiments, namely a first to a fourth embodiment. In the image shooting apparatus 1, whether or not to execute blur correction processing is controlled. Roughly classified, this control is performed either based on the shooting parameters of an ordinary-exposure image or based on the degree of blur of a short-exposure image. Control based on the shooting parameters of an ordinary-exposure image will be described in connection with the first and second embodiments, and control based on the degree of blur of a short-exposure image will be described in connection with the third embodiment. It is to be noted that the input of an ordinary-exposure image and a short-exposure image to the correction control portion 52 as shown in FIG. 3 functions effectively in the third embodiment.

In the present specification, data representing an image is called image data; however, in passages describing a specific type of processing (recording, storage, reading-out, etc.) performed on the image data of a given image, for the sake of simple description, the image itself may be mentioned in place of its image data: for example, the phrase “record the image data of a still image” is synonymous with the phrase “record a still image”. Again for the sake of simple description, in the following description, it is assumed that the aperture value (the degree of aperture) of the aperture stop 32 remains constant.

### First Embodiment

Now a first embodiment of the invention will be described. Usually a short-exposure image contains a smaller degree of blur than an ordinary-exposure image; thus, by correcting an ordinary-exposure image with the aim set for the edge condition of a short-exposure image, it is possible to reduce blur in the ordinary-exposure image. To obtain a sufficient blur correction effect, however, it is necessary to give a short-exposure image an adequately high signal-to-noise ratio (hereinafter referred to as “S/N ratio”). In actual shooting, however, it may be impossible to shoot a short-exposure image that permits a sufficient blur correction effect. In such a case, forcibly performing short-exposure shooting and blur correction processing does not produce a satisfactory blur correction effect (even a corrupted image may be generated). With these circumstances taken into consideration, in the first embodiment, whenever it is judged that it is impossible to acquire a short-exposure image that permits a sufficient blur correction effect, shooting of a short-exposure image and blur correction processing are not executed.

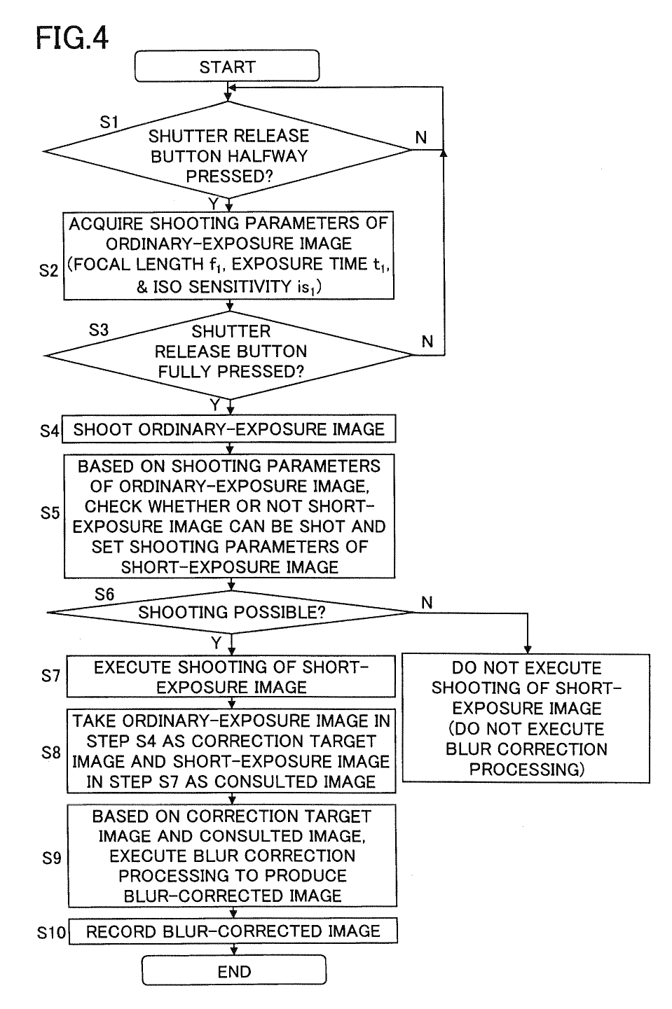

With reference to FIG. 4, the shooting and correction operation of the image shooting apparatus 1 according to the first embodiment will be described. FIG. 4 is a flow chart showing the flow of the operation. The processing in steps S1 through S10 is executed within the image shooting apparatus 1.

First, in step S1, the main control portion 13 in FIG. 1 checks whether or not the shutter release button 17a is in the halfway pressed state. If it is found to be in the halfway pressed state, an advance is made from step S1 to step S2.

In step S2, the shooting control portion 51 acquires the shooting parameters of an ordinary-exposure image. The shooting parameters of an ordinary-exposure image include the focal length f₁, the exposure time t₁, and the ISO sensitivity is₁ during the shooting of the ordinary-exposure image.

The focal length f₁ is determined based on the positions of the lenses inside the optical system 35 during the shooting of the ordinary-exposure image, previously known information, etc. In the following description, it is assumed that any focal length, including the focal length f₁, is a 35 mm film equivalent focal length. The shooting control portion 51 is provided with a metering portion (unillustrated) that measures the brightness of an object (in other words, the amount of light incident on the image-sensing portion 11) based on the output signal of a metering sensor (unillustrated) provided in the image shooting apparatus 1 or based on the output signal of the image sensor 33. Based on the measurement result, the shooting control portion 51 determines the exposure time t₁ and the ISO sensitivity is₁ so that an ordinary-exposure image with proper brightness is obtained.

The ISO sensitivity denotes the sensitivity defined by ISO (International Organization for Standardization), and adjusting the ISO sensitivity permits adjustment of the brightness (luminance level) of a shot image. In practice, the amplification factor for signal amplification in the AFE 12 is determined according to the ISO sensitivity. The amplification factor is proportional to the ISO sensitivity. As the ISO sensitivity doubles, the amplification factor doubles, and accordingly the luminance values of the individual pixels of a shot image double (provided that saturation is ignored).

Needless to say, the other conditions being equal, the luminance values of the individual pixels of a shot image are proportional to the exposure time; thus, as the exposure time doubles, the luminance values of the individual pixels double (provided that saturation is ignored). A luminance value is the value of the luminance signal at a pixel among those composing a shot image. For a given pixel, as the luminance value there increases, the brightness of that pixel increases.

Subsequent to step S2, in step S3, the main control portion 13 checks whether or not the shutter release button 17a is in the fully pressed state. If it is in the fully pressed state, an advance is made to step S4; if it is not in the fully pressed state, a return is made to step S1.

In step S4, the image shooting apparatus 1 (image-sensing portion 11) performs ordinary-exposure shooting to acquire an ordinary-exposure image. The shooting control portion 51 controls the image-sensing portion 11 and the AFE 12 so that the focal length, the exposure time, and the ISO sensitivity during the shooting of the ordinary-exposure image equal the focal length f₁, the exposure time t₁, and the ISO sensitivity is₁.

Then in step S5, based on the shooting parameters of the ordinary-exposure image, the short-exposure shooting control portion 54 judges whether or not to shoot a short-exposure image, and in addition sets the shooting parameters of a short-exposure image. The judging and setting methods here will be described later and, before that, the processing subsequent to step S5, that is, the processing in step S6 and the following steps, will be described.

In step S6, based on the judgment result of whether or not to shoot a short-exposure image, branching is performed so that based on the judgment result the short-exposure shooting control portion 54 controls the shooting by the image-sensing portion 11. Specifically, if, in step S5, it is judged that it is practicable to shoot a short-exposure image, an advance is made from step S6 to step S7. In step S7, the short-exposure shooting control portion 54 controls the image-sensing portion 11 so that short-exposure shooting is performed. Thus a short-exposure image is acquired. To minimize the change of the shooting environment (including the movement of the subject) between the shooting of the ordinary-exposure image and the shooting of the short-exposure image, the short-exposure image is shot immediately after the shooting of the ordinary-exposure image. By contrast, if, in step S5, it is found that it is impracticable to shoot a short-exposure image, no short-exposure image is shot (that is, the short-exposure shooting control portion 54 does not control the image-sensing portion 11 for the purpose of shooting a short-exposure image).

The judgment result of whether or not to shoot a short-exposure image is transmitted to the correction control portion 52 in FIG. 3, and based on the judgment result the correction control portion 52 controls whether or not to make the blur correction processing portion 53 execute blur correction processing. Specifically, if it is found that it is practicable to shoot a short-exposure image, blur correction processing is enabled; if it is found that it is impracticable to shoot a short-exposure image, blur correction processing is disabled.

Subsequent to the shooting of the short-exposure image, in step S8, the blur correction processing portion 53 handles the ordinary-exposure image obtained in step S4 and the short-exposure image obtained in step S7 as a correction target image and as a consulted image respectively, and receives the image data of the correction target image and of the consulted image (in other words, reference image). Then, in step S9, based on the correction target image and the consulted image the blur correction processing portion 53 executes blur correction processing to reduce blur in the correction target image. Through the blur correction processing here, a blur-reduced correction target image is generated, which is called the blur-corrected image. Subsequent to step S9, in step S10, the image data of the thus generated blur-corrected image is recorded to the recording medium 16.

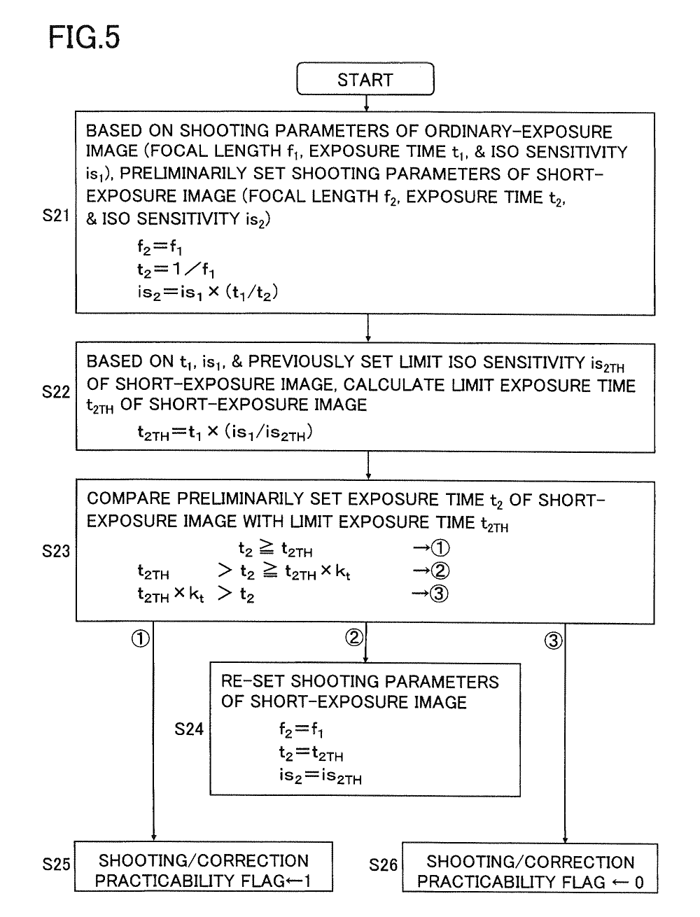

With reference to FIG. 5, the method of judging whether or not to shoot a short-exposure image and the method of setting the shooting parameters of a short-exposure image will be described. FIG. 5 is a detailed flow chart of step S5 in FIG. 4; the processing in step S5 is achieved by the short-exposure shooting control portion 54 executing the processing in steps S21 through S26 in FIG. 5.

The processing in steps S21 through S26 will now be described step by step. First, the processing in step S21 is executed. In step S21, based on the shooting parameters of the ordinary-exposure image, the short-exposure shooting control portion 54 preliminarily sets the shooting parameters of a short-exposure image. Here, the shooting parameters are preliminary set such that the short-exposure image contains a negligibly small degree of blur and is substantially as bright as the ordinary-exposure image. The shooting parameters of a short-exposure image includes the focal length f₂, the exposure time t₂, and the ISO sensitivity is₂ during the shooting of the short-exposure image.

Generally, the reciprocal of the 35 mm film equivalent focal length of an optical system is called the motion blur limit exposure time and, when a still image is shot with an exposure time equal to or shorter than the motion blur limit exposure time, the still image contains a negligibly small degree of blur. For example, with a 35 mm film equivalent focal length of 100 mm, the motion blur limit exposure time is 1/100 seconds. Moreover, generally, in a case where the exposure time is 1/a of the proper exposure time, to obtain an image with proper brightness, the ISO sensitivity needs to be multiplied by a factor of “a” (here “a” is a positive value). Moreover, in step S21, the focal length for short-exposure shooting is set equal to the focal length for ordinary-exposure shooting.

Accordingly, in step S21, the shooting parameters of the short-exposure image are preliminarily set such that “f₂=f₁, t₂=1/f₁, and is₂=is₁×(t₁/t₂)”.

Subsequent to the preliminary setting in step S21, in step S22, based on the exposure time t₁ and the ISO sensitivity is₁ of the ordinary-exposure image and the limit ISO sensitivity is_{2TH} of the short-exposure image, the limit exposure time t_{2TH} of the short-exposure image is calculated according to the formula “t_{2TH}=t₁×(is₁/is_{2TH})”.

The limit ISO sensitivity is_{2TH} is the border ISO sensitivity with respect to whether or not the S/N ratio of the short-exposure image is satisfactory, and is set previously according to the characteristics of the image-sensing portion 11 and the AFE 12 etc. When a short-exposure image is acquired at an ISO sensitivity higher than the limit ISO sensitivity is_{2TH}, its S/N ratio is too low to obtain a sufficient blur correction effect. The limit exposure time t_{2TH} derived from the limit ISO sensitivity is_{2TH} is the border exposure time with respect to whether or not the S/N ratio of a short-exposure image is satisfactory.

Then, in step S23, the exposure time t₂ of the short-exposure image as preliminarily set in step S21 is compared with the limit exposure time t_{2TH} calculated in step S22 to distinguish the following three cases. Specifically, it is checked which of a first inequality “t₂≧t_{2TH}”, a second inequality “t_{2TH}>t₂≧t_{2TH}×kₜ”, and a third inequality “t_{2TH}×kₜ>t₂” is fulfilled and, according to the check result, branching is performed as described below. Here, kₜ represents a previously set limit exposure time coefficient fulfilling 0<kₜ<1.

In a case where the first inequality is fulfilled, even if the exposure time of the short-exposure image is set equal to the motion blur limit exposure time (1/f₁), it is possible to shoot a short-exposure image with a sufficient S/N ratio. A sufficient S/N ratio is one high enough to bring a sufficient blur correction effect.

Accordingly, in a case where the first inequality is fulfilled, an advance is made from step S23 directly to step S25 so that, with “1” substituted in a shooting/correction practicability flag FG and by use of the shooting parameters preliminarily set in step S21 as they are, the short-exposure shooting in step S7 is performed. Specifically, in a case where the first inequality is fulfilled, the short-exposure shooting control portion 54 controls the image-sensing portion 11 and the AFE 12 such that the focal length, the exposure time, and the ISO sensitivity during the shooting of the short-exposure image in step S7 in FIG. 4 equal the focal length f₂ (=f₁), the exposure time t₂ (=1/f₁), and the ISO sensitivity is₂ (=is₁×(t₁/t₂)) as calculated in step S21.

The shooting/correction practicability flag FG is a flag that represents the judgment result of whether or not to shoot a short-exposure image and whether or not to execute blur correction processing, and the individual blocks within the main control portion 13 operate according to the value of the flag FG. When the flag FG has a value of “1”, it indicates that it is practicable to shoot a short-exposure image and that it is practicable to execute blur correction processing; when the flag FG has a value of “0”, it indicates that it is impracticable to shoot a short-exposure image and that it is impracticable to execute blur correction processing.

In a case where the second inequality is fulfilled, if the exposure time of the short-exposure image is set equal to the motion blur limit exposure time (1/f₁), it is not possible to shoot a short-exposure image with a sufficient S/N ratio. Even then, in this case, it is expected that, even if the exposure time of the short-exposure image is set equal to the limit exposure time t_{2TH}, a relatively small degree of blur will result. Accordingly, fulfillment of the second inequality indicates that, provided that the exposure time of the short-exposure image is set at a length of time (t_{2TH}) with which a relatively small degree of blur is expected to result, it is possible to shoot a short-exposure image with a sufficient S/N ratio.

Accordingly, when the second inequality is fulfilled, an advance is made from step S23 to step S24 so that first the shooting parameters of the short-exposure image are re-set such that “f₂=f₁, t₂=t_{2TH}, and is₂=is_{2TH}”, and then “1” is substituted in the flag FG. Thus, by use of the shooting parameters thus re-set, the short-exposure shooting in step S7 in FIG. 4 is executed. Specifically, when the second inequality is fulfilled, the short-exposure shooting control portion 54 controls the image-sensing portion 11 and the AFE 12 such that the focal length, the exposure time, and the ISO sensitivity during the shooting of the short-exposure image in step S7 in FIG. 4 equal the focal length f₂ (=f₁), the exposure time t₂ (=t_{2TH}), and the ISO sensitivity is₂ (=is_{2TH}) as re-set in step S24.

In a case where the third inequality is fulfilled, if the exposure time of the short-exposure image is set equal to the motion blur limit exposure time (1/f₁), it is not possible to shoot a short-exposure image with a sufficient S/N ratio. In addition, even if the exposure time of the short-exposure image is set at a length of time (t_{2TH}) with which a relatively small degree of blur is expected to result, it is not possible to shoot a short-exposure image with a sufficient S/N ratio.

Accordingly, in a case where the third inequality is fulfilled, an advance is made from step S23 to step S26 so that it is judged that it is impracticable to shoot a short-exposure image and “0” is substituted in the flag FG. Thus, shooting of a short-exposure image is not executed.

In a case where the first or second inequality is fulfilled, “1” is substituted in the flag FG, and thus the blur correction processing portion 53 executes blur correction processing; by contrast, in a case where the third inequality is fulfilled, “0” is substituted in the flag FG, and thus the blur correction processing portion 53 does not execute blur correction processing.

A specific numerical example will now be taken up. In a case where the shooting parameters of the ordinary-exposure image are “f₁=100 mm, t₁=1/10 seconds, and is₁=100”, in step S21, the shooting parameters of the short-exposure image are preliminarily set at “f₂=100 mm, t₂=1/100 seconds, and is₂=1000”. Here, if the limit ISO sensitivity of the short-exposure image has been set at is_{2TH}=800, the limit exposure time t_{2TH} of the short-exposure image is set at 1/80 seconds (step S22). Then “t_{2TH}=1/80>1/100”, and therefore the first inequality is not fulfilled. This means that, if short-exposure shooting is performed by use of the preliminarily set shooting parameters, it is not possible to obtain a short-exposure image with a sufficient S/N ratio.

Even then, in a case where, for example, the limit exposure time coefficient kₜ is 0.5, “1/100≧t_{2TH}×kₜ”, and therefore the second inequality is fulfilled. In this case, re-setting the exposure time t₂ and the ISO sensitivity is₂ of the short-exposure image such that they equal the limit exposure time t_{2TH} and the limit ISO sensitivity is_{2TH} makes it possible to shoot a short-exposure image with a sufficient S/N ratio, and thus by performing blur correction processing by use of that short-exposure image it is possible to obtain a sufficient blur correction effect.

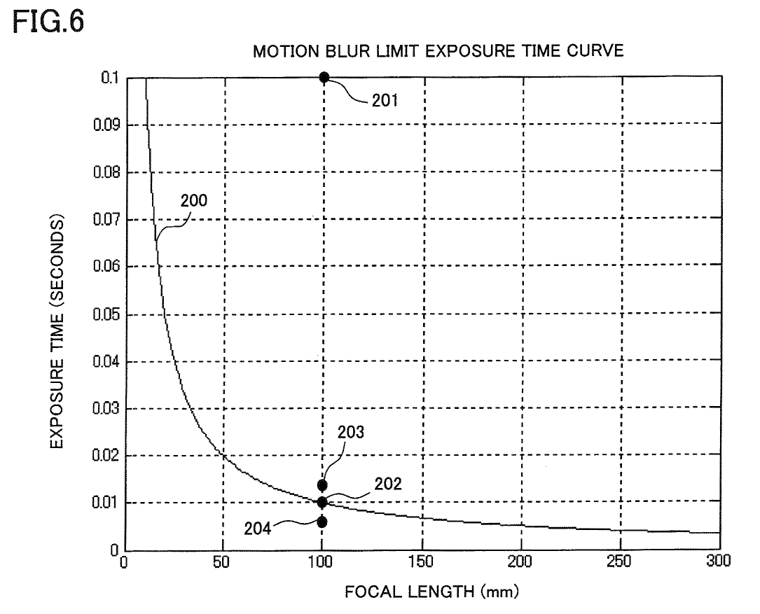

FIG. 6 shows a curve 200 representing the relationship between the focal length and the motion blur limit exposure time. Points 201 to 204 corresponding to the numerical example described above are plotted on the graph of FIG. 6. The point 201 corresponds to the shooting parameters of the ordinary-exposure image; the point 202, lying on the curve 200, corresponds to the preliminarily set shooting parameters of the short-exposure image; the point 203 corresponds to the state in which the focal length and the exposure time are 10 mm and t_{2TH} (=1/80 seconds); the point 204 corresponds to the state in which the focal length and the exposure time are 100 mm and t_{2TH}×kₜ (=1/160 seconds).

As described above, to reduce blur in a short-exposure image to a negligible degree, it is common to set the exposure time of the short-exposure image equal to or shorter than the motion blur limit exposure time. However, even when the former is slightly longer than the latter, it is still possible to obtain a short-exposure image with a degree of blur so small as to be practically acceptable. Specifically, even when the limit exposure time t_{2TH} of the short-exposure image (in the above numerical example, 1/80 seconds) is longer than the motion blur limit exposure time (in the above numerical example, 1/100 seconds), if kₜ times the limit exposure time t_{2TH} of the short-exposure image (in the above numerical example, t_{2TH}×kₜ=1/160 seconds) is equal to or shorter than the motion blur limit exposure time, by performing short-exposure shooting by use of that limit exposure time t_{2TH}, it is possible to acquire a short-exposure image with a degree of blur so small as to be practically acceptable (put the other way around, the value of the limit exposure time coefficient kₜ is set previously through experiments or the like so as to fulfill the above relationship). In view of this, even in a case where the first inequality is not fulfilled, provided that the second inequality is fulfilled, the re-setting in step S24 is executed so that shooting of a short-exposure image is enabled.

As described above, in the first embodiment, based on the shooting parameters of an ordinary-exposure image which reflect the actual shooting environment conditions (such as the ambient illuminance around the image shooting apparatus 1), it is checked whether or not it is possible to shoot a short-exposure image with an S/N ratio high enough to permit a sufficient blur correction effect and, according to the check result, whether or not to shoot a short-exposure image and whether or not to execute blur correction processing are controlled. In this way, it is possible to obtain a stable blur correction effect and thereby avoid generating an image with hardly any correction effect (or a corrupted image) as a result of forcibly performed blur correction processing.

### Second Embodiment

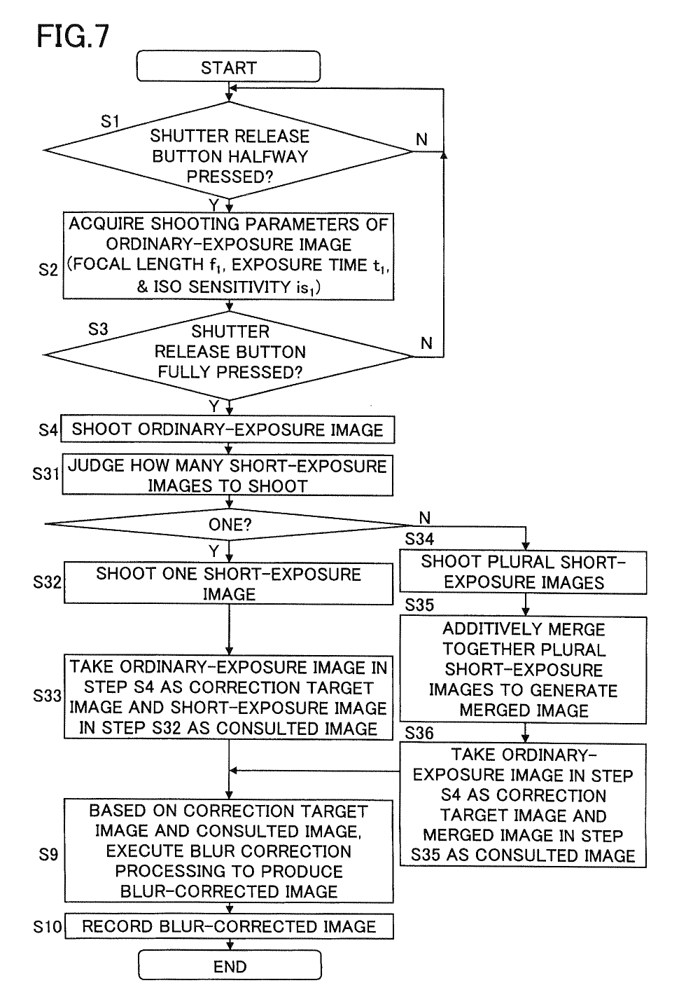

Next, a second embodiment of the invention will be described. Part of the operation described in connection with the first embodiment is used in the second embodiment as well. With reference to FIG. 7, the shooting and correction operation of the image shooting apparatus 1 according to the second embodiment will be described. FIG. 7 is a flow chart showing the flow of the operation. Also in the second embodiment, first, the processing in steps S1 through S4 is performed. The processing in steps S1 through S4 here is the same as that described in connection with the first embodiment.

Specifically, when the shutter release button 17a is brought into the halfway pressed state, the shooting control portion 51 acquires the shooting parameters of an ordinary-exposure image (the focal length f₁, the exposure time t₁, and the ISO sensitivity is₁). Thereafter, when the shutter release button 17a is brought into the fully pressed state, in step S4, by use of those shooting parameters, ordinary-exposure shooting is performed to acquire an ordinary-exposure image. In the second embodiment, after the shooting of the ordinary-exposure image, an advance is made to step S31.

In step S31, based on the shooting parameters of the ordinary-exposure image, the short-exposure shooting control portion 54 judges whether to shoot one short-exposure image or a plurality of short-exposure images.

Specifically, first, the short-exposure shooting control portion 54 executes the same processing as in steps S21 and S22 in FIG. 5. Specifically, in step S21, by use of the focal length f₁, the exposure time t₁, and the ISO sensitivity is₁ included in the shooting parameters of the ordinary-exposure image, the shooting parameters of the short-exposure image are preliminarily set such that “f₂=f₁, t₂=1/f₁, and is₂=is₁×(t₁/t₂)”, and then, in step S22, the limit exposure time t_{2TH} of the short-exposure image is found according to the formula “t_{2TH}=t₁×(is₁/is_{2TH})”.

Then the exposure time t₂ of the short-exposure image as preliminarily set in step S21 is compared with the limit exposure time t_{2TH} calculated in step S22 to check which of the first inequality “t₂≧t_{2TH}”, the second inequality “t_{2TH}>t₂≧t_{2TH}×kₜ”, and the third inequality “t_{2TH}×kₜ>t₂” is fulfilled. Here, kₜ is the same as the one mentioned in connection with the first embodiment.

Then, in a case where the first or second inequality is fulfilled, it is judged that the number of short-exposure images to be shot is one, and an advance is made from step S31 to step S32, so that the processing in steps S32, S33, S9, and S10 is executed sequentially. The result of the judgment that the number of short-exposure images to be shot is one is transmitted to the correction control portion 52 and, in this case, the correction control portion 52 controls the blur correction processing portion 53 so that the ordinary-exposure image obtained in step S4 and the short-exposure image obtained in step S32 are handled as a correction target image and a consulted image respectively.

Specifically, in step S32, the short-exposure shooting control portion 54 controls shooting so that short-exposure shooting is performed once. Through this short-exposure shooting, one short-exposure image is acquired. This short-exposure image is shot immediately after the shooting of the ordinary-exposure image. Subsequently, in step S33, the blur correction processing portion 53 handles the ordinary-exposure image obtained in step S4 and the short-exposure image obtained in step S32 as a correction target image and a consulted image respectively, and receives the image data of the correction target image and the consulted image. Then, in step S9, based on the correction target image and the consulted image, the blur correction processing portion 53 executes blur correction processing to reduce blur in the correction target image, and thereby generates a blur-corrected image. Subsequent to S9, in step S10, the image data of the thus generated blur-corrected image is recorded to the recording medium 16.

As in the first embodiment, in a case where the first inequality is fulfilled, by use of the shooting parameters preliminarily set in step S21 as they are, the short-exposure shooting in step S32 is performed. Specifically, in a case where the first inequality is fulfilled, the short-exposure shooting control portion 54 controls the image-sensing portion 11 and the AFE 12 such that the focal length, the exposure time, and the ISO sensitivity during the shooting of the short-exposure image in step S32 equal the focal length f₂ (=f₁), the exposure time t₂ (=1/f₁), and the ISO sensitivity is₂ (=is₁×(t₁/t₂)) as calculated in step S21. In a case where the second inequality is fulfilled, the processing in step S24 in FIG. 5 is executed to re-set the shooting parameters of the short-exposure image and, by use of the thus re-set shooting parameters, the short-exposure shooting in step S32 is performed. Specifically, in a case where the second inequality is fulfilled, the short-exposure shooting control portion 54 controls the image-sensing portion 11 and the AFE 12 such that the focal length, the exposure time, and the ISO sensitivity during the shooting of the short-exposure image in step S32 equal the focal length f₂ (=f₁), the exposure time t₂ (=t_{2TH}), and the ISO sensitivity is₂ (=is_{2TH}) as re-set in step S24.

In a case where, in step S31, the third inequality “t_{2TH}×kₜ>t₂” is fulfilled, it is judged that the number of short-exposure images to be shot is plural, and an advance is made from step S31 to step S34 so that first the processing in steps S34 through S36 is executed and then the processing in steps S9 through S10 is executed. The result of the judgment that the number of short-exposure images to be shot is plural is transmitted to the correction control portion 52 and, in this case, the correction control portion 52 controls the blur correction processing portion 53 so that the ordinary-exposure image obtained in step S4 and the merged image obtained in step S35 are handled as a correction target image and a consulted image respectively. As will be described in detail later, the merged image is generated by additively merging together a plurality of short-exposure images.

The processing in steps S34 through S36 will now be described step by step. In step S34, immediately after the shooting of the ordinary-exposure image, nₛ short-exposure images are shot consecutively. To that end, first, the short-exposure shooting control portion 54 determines the number of short-exposure images to be shot (that is, the value of nₛ) and the shooting parameters of the short-exposure images. Here, nₛ is an integer of 2 or more. The focal length, the exposure time, and the ISO sensitivity during the shooting of each short-exposure image as acquired in step S34 are represented by f₃, t₃, and is₃ respectively, and the method for determining nₛ, f₃, t₃, and is₃ will now be described. In the following description, the shooting parameters (f₂, t₂, and is₂) preliminarily set in step S21 will also be referred to.

The values of nₛ, f₃, t₃, and is₃ are so determined as to fulfill all of the first to third conditions noted below.

The first condition is that “kₜ times the exposure time t₃ is equal to or shorter than the motion blur limit exposure time”. The first condition is provided to make blur in each short-exposure image so small as to be practically acceptable. To fulfill the first condition, the inequality “t₂≧t₃×kₜ” needs to be fulfilled.

The second condition is that “the brightness of the ordinary-exposure image and the brightness of the merged image to be obtained in step S35 are equal (or substantially equal)”. To fulfill the second condition, the inequality “t₃×is₃×nₛ=t₁×is₁” needs to be fulfilled.

The third condition is that “the ISO sensitivity of the merged image to be obtained in step S35 is equal to or lower than the limit ISO sensitivity of the short-exposure image”. The third condition is provided to obtain a merged image with a sufficient S/N ratio. To fulfill the third condition, the inequality “is₃×\sqrt{nₛ}≦is_{2TH}” needs to be fulfilled,

Generally, the ISO sensitivity of the image obtained by additively merging together nₛ images each with an ISO sensitivity of is₃ is given by is₃×\sqrt{nₛ}. Here, \sqrt{nₛ} represents the positive square root of nₛ.

A specific numerical example will now be taken up. Consider now a case where the shooting parameters of the ordinary-exposure image are “f₁=200 mm, t₁=1/10 seconds, and is₁=100”. Assume in addition that the limit ISO sensitivity is_{2TH} of the short-exposure image is 800 and that the limit exposure time coefficient kₜ is 0.5. Then, in the preliminary setting of the shooting parameters of the short-exposure image in step S21 in FIG. 5, they are set at “f₂=200 mm, t₂=1/200 seconds, and is₂=2000”. On the other hand, since t_{2TH}=t₁×(is₁/is_{2TH})=1/80, the limit exposure time t_{2TH} is 1/80 seconds. Thus “t_{2TH}×kₜ>t₂” is fulfilled, and therefore an advance is made from step S31 in FIG. 7 to step S34.

In this case, to fulfill the first condition, formula (A-1) below needs to be fulfilled.

1/100≧t₃ (A-1)

Suppose that 1/100 is substituted in t₃. Then, according to the equation corresponding to the second condition, formula (A-2) below needs to be fulfilled. In addition, formula (A-3) corresponding to the third condition also needs to be fulfilled. Formulae (A-2) and (A-3) give “nₛ≧1.5625”, indicating that nₛ needs to be set at 2 or more.

is₃×nₛ=1000 (A-2)

is₃×\sqrt{nₛ}≦800 (A-3)

Suppose that 2 is substituted in nₛ. Then the equation corresponding to the second condition becomes formula (A-4) below and the inequality corresponding to the third condition becomes formula (A-5) below.

t₃×is₃=5 (A-4)

is₃≦800/1.414≈566 (A-5)

Formulae (A-4) and (A-5) give “t₃≧0.0088”. Considered together with formula (A-1), this indicates that, even when nₛ=2, setting t₃ such that it fulfills “1/100≧t₃≧0.0088” makes it possible to generate a merged image that is expected to produce a sufficient blur correction effect. Once nₛ and t₃ are determined, is₃ is determined automatically. Here f₃ is set equal to f₁. In the example described above, with 2 substituted in nₛ, t₃ can be so set as to fulfill all the first to third conditions. In a case where this is not possible, the value of nₛ needs to be gradually increased until the desired setting is possible.

In step S34, by the method described above, the values of nₛ, f₃, t₃, and is₃ are found and, according to these, short-exposure shooting is performed nₛ times. The image data of the nₛ short-exposure images acquired in step S34 is fed to the blur correction processing portion 53. The blur correction processing portion 53 additively merges these nₛ short-exposure images to generate a merged image (a merged image may be read as a blended image). The method for additive merging will be described below.

The blur correction processing portion 53 first adjusts the positions of the nₛ short-exposure images and then merges them together. For the sake of concrete description, consider a case where nₛ is 3 and thus, after the shooting of an ordinary-exposure image, a first, a second, and a third short-exposure image are shot sequentially. In this case, for example, with the first short-exposure image taken as a datum image and the second and third short-exposure images taken as non-datum images, the positions of the non-datum images are adjusted to that of the datum image, and then all the images are merged together. It is to be noted that “position adjustment” here is synonymous with “displacement correction” discussed later.

The processing for position adjustment and then merging together of one datum image and one non-datum image will now be explained. For example by use of the Harris corner detector, a characteristic small region (for example, a small region of 32×32 pixels) is extracted from the datum image. A characteristic small region is a rectangular region in the extraction target image which contains a relatively large edge component (in other words, a relatively strong contrast), and it is, for example, a region including a characteristic pattern. A characteristic pattern is one, like a corner part of an object, that exhibits varying luminance in two or more directions and that, based on that variation in luminance, permits easy detection of the position of the pattern (its position in the image) through image processing. Then the image within the small region thus extracted from the datum image is taken as a template, and, by template matching, a small region most similar to that template is searched for in the non-datum image. Then the displacement of the position of the thus found small region (the position in the non-datum image) from the position of the small region extracted from the datum image (the position in the datum image) is calculated as the amount of displacement Δd. The amount of displacement Δd is a two-dimensional quantity containing a horizontal and a vertical component, and is expressed as a so-called motion vector. The non-datum image can be regarded as an image displaced by the distance and in the direction equivalent to the amount of displacement Δd relative to the datum image. Accordingly, by applying coordinate conversion (such as affine transform) to the non-datum image in such a way as to cancel the amount of displacement Δd, the displacement of the non-datum image is corrected. For example, a geometric conversion parameter for performing the desired coordinate conversion is found, and the coordinates of the non-datum image are converted onto the coordinate system on which the datum image is defined; thus displacement correction is achieved. Through displacement correction, a pixel located at coordinates (x+Δdx, y+Δdy) on the non-datum image before displacement correction is converted to a pixel located at coordinates (x, y). The symbols Δdx and Δdy represent the horizontal and vertical components, respectively, of Δd. Then, by adding up the corresponding pixel signals between the datum image and the non-datum image after displacement correction, these images are merged together. The pixel signal of a pixel located at coordinates (x, y) on the image obtained by merging is equivalent to the sum signal of the pixel signal of a pixel located at coordinates (x, y) on the datum image and the pixel signal of a pixel located at coordinates (x, y) on the non-datum image after displacement correction.

The above-described processing for position adjustment and merging is executed with respect to each non-datum image. As a result, the first short-exposure image, on one hand, and the second and third short-exposure images after position adjustment, on the other hand, are merged together into a merged image. This merged image is the merged image to be generated in step S35 in FIG. 7. Instead, it is also possible to extract a plurality of characteristic small regions from the datum image, then search for a plurality of small regions corresponding to those small regions in a non-datum image by template matching, then find the above-mentioned geometric conversion parameter from the small regions extracted from the datum image and the small regions found in the non-datum image, and then perform the above-described displacement correction.

After the merged image is generated in step S35, in step S36, the blur correction processing portion 53 handles the ordinary-exposure image obtained in step S4 as a correction target image, and receives the image data of the correction target image; in addition, the blur correction processing portion 53 handles the merged image generated in step S35 as a consulted image. Then the processing in steps S9 and S10 is executed. Specifically, based on the correction target image and the consulted image, which is here the merged image, the blur correction processing portion 53 executes blur correction processing to reduce blur in the correction target image, and thereby generates a blur-corrected image. Subsequent to step S9, in step S10, the image data of the thus generated blur-corrected image is recorded to the recording medium 16.

As described above, in the second embodiment, based on the shooting parameters of an ordinary-exposure image which reflect the actual shooting environment conditions (such as the ambient illuminance around the image shooting apparatus 1), it is judged how many short-exposure images need to be shot to obtain a sufficient blur correction effect and, by use of one short-exposure image or a plurality of short-exposure images obtained according to the result of the judgment, blur correction processing is executed. In this way, it is possible to obtain a stable blur correction effect

### Third Embodiment

Next, a third embodiment of the invention will be described. When a short-exposure image containing a negligibly small degree of blur is acquired, by correcting an ordinary-exposure image with the aim set for the edge condition of the short-exposure image, it is possible to obtain a sufficient blur correction effect. However, even when the exposure time of the short-exposure image is so set as to obtain such a short-exposure image, in reality, depending on the shooting skill of the photographer and other factors, the short-exposure image may contain a non-negligible degree of blur. In such a case, even when blur correction processing based on the short-exposure image is performed, it is difficult to obtain a satisfactory blur correction effect (even a corrupted image may result).

In view of this, in the third embodiment, the correction control portion 52 in FIG. 3 estimates, based on an ordinary-exposure image and a short-exposure image, the degree of blur contained in the short-exposure image and, only if it has estimated the degree of blur to be relatively small, judges that it is practicable to execute blur correction processing based on the short-exposure image.

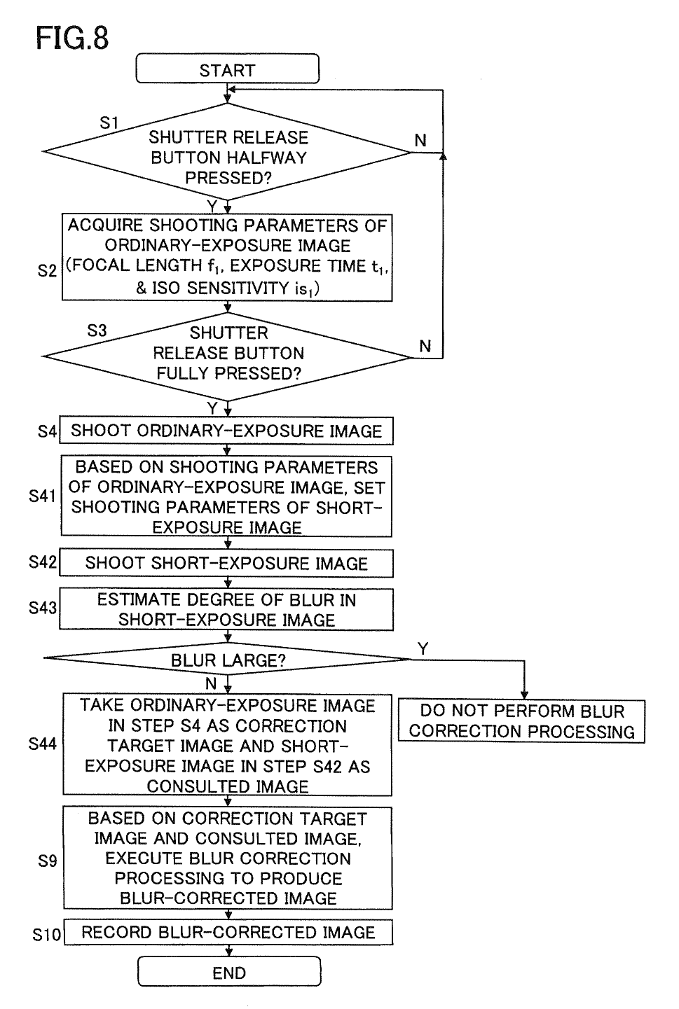

With reference to FIG. 8, the shooting and correction operation of the image shooting apparatus 1 according to the third embodiment will be described. FIG. 8 is a flow chart showing the flow of the operation. Also in the third embodiment, first, the processing in steps S1 through S4 is performed. The processing in steps S1 through S4 here is the same as that described in connection with the first embodiment.

Specifically, when the shutter release button 17a is brought into the halfway pressed state, the shooting control portion 51 acquires the shooting parameters of an ordinary-exposure image (the focal length f₁, the exposure time t₁, and the ISO sensitivity is₁). Thereafter, when the shutter release button 17a is brought into the fully pressed state, in step S4, by use of those shooting parameters, ordinary-exposure shooting is performed to acquire an ordinary-exposure image. In the third embodiment, after the shooting of the ordinary-exposure image, an advance is made to step S41.

In step S41, based on the shooting parameters of the ordinary-exposure image, the short-exposure shooting control portion 54 sets the shooting parameters of a short-exposure image. Specifically, by use of the focal length f₁, the exposure time t₁, and the ISO sensitivity is₁ included in the shooting parameters of the ordinary-exposure image, the shooting parameters of the short-exposure image are set such that “f₂=f₁, t₂=t₁×k_{Q}, and is₂₌ᵢₛ₁×(t₁/t₂)”. Here the coefficient k_{Q} is a coefficient set previously such that it fulfills the inequality “0<k_{Q}<1”, and has a value of, for example, about 0.1 to 0.5.

Subsequently, in step S42, the short-exposure shooting control portion 54 controls shooting so that short-exposure shooting is performed according to the shooting parameters of the short-exposure image as set in step S41. Through this short-exposure shooting, one short-exposure image is acquired. This short-exposure image is shot immediately after the shooting of the ordinary-exposure image. Specifically, the short-exposure shooting control portion 54 controls the image-sensing portion 11 and the AFE 12 such that the focal length, the exposure time, and the ISO sensitivity during the shooting of the short-exposure image equal the focal length f₂ (=f₁), the exposure time t₂ (=t₁×k_{Q}), and the ISO sensitivity is₂ (=is₁×(t₁/t₂)) set in step S41.

Subsequently, in step S43, based on the image data of the ordinary-exposure image and the short-exposure image obtained in steps S4 and S42, the correction control portion 52 estimates the degree of blur in (contained in) the short-exposure image. The method for estimation here will be described later.

In a case where the correction control portion 52 judges the degree of blur in the short-exposure image to be relatively small, an advance is made from step S43 to step S44 so that the processing in steps S44, S9, and S10 is executed. Specifically, in a case where the degree of blur is judged to be relatively small, the correction control portion 52 judges that it is practicable to execute blur correction processing, and controls the blur correction processing portion 53 so as to execute blur correction processing. So controlled, the blur correction processing portion 53 handles the ordinary-exposure image obtained in step S4 and the short-exposure image obtained in step S42 as a correction target image and a consulted image respectively, and receives the image data of the correction target image and the consulted image. Then, in step S9, based on the correction target image and the consulted image, the blur correction processing portion 53 executes blur correction processing to reduce blur in the correction target image, and thereby generates a blur-corrected image. Subsequent to step S9, in step S10, the image data of the thus generated blur-corrected image is recorded to the recording medium 16.

By contrast, in a case where the correction control portion 52 judges the degree of blur in the short-exposure image to be relatively large, the correction control portion 52 judges that it is impractical to execute blur correction processing, and controls the blur correction processing portion 53 so as not to execute blur correction processing.

As described above, in the third embodiment, the degree of blur in a short-exposure image is estimated and, only if the degree of blur is judged to be relatively small, blur correction processing is executed. Thus it is possible to obtain a stable blur correction effect and thereby avoid generating an image with hardly any correction effect (or a corrupted image) as a result of forcibly performed blur correction processing.

Instead, it is also possible to set the shooting parameters of a short-exposure image by the method described in connection with the first embodiment. Specifically, it is possible to set the shooting parameters of a short-exposure image by executing in step S41 the processing in steps S21 through S26 in FIG. 5. In this case, during the shooting of the short-exposure image in step S42, the image-sensing portion 11 and the AFE 12 are controlled such that “f₂=f₁, t₂=1/f₁, and is₂=is₁×(t₁/t₂)”, or such that “f₂=f₁, t₂=t_{2TH}, and is₂=is_{2TH}”. In a case where, with respect to the exposure time t₂ preliminarily set in step S21 in FIG. 5, the inequality “t_{2TH}×kₜ>t₂” is fulfilled, it is possible even to do away with performing the shooting of a short-exposure image in step S42.

The method for estimating the degree of blur in a short-exposure image will be described below. As examples of estimation methods adoptable here, three estimation methods, namely a first to a third estimation method, will be presented below one by one. It is assumed that, in the description of the first to third estimation methods, the ordinary-exposure image and the short-exposure image refers to the ordinary-exposure image and the short-exposure image obtained in steps S4 and step S42, respectively, in FIG. 8.

First Estimation Method: First, a first estimation method will be described. In the first estimation method, the degree of blur in the short-exposure image is estimated by comparing the edge intensity of the ordinary-exposure image with the edge intensity of the short-exposure image. A more specific description will now be given.

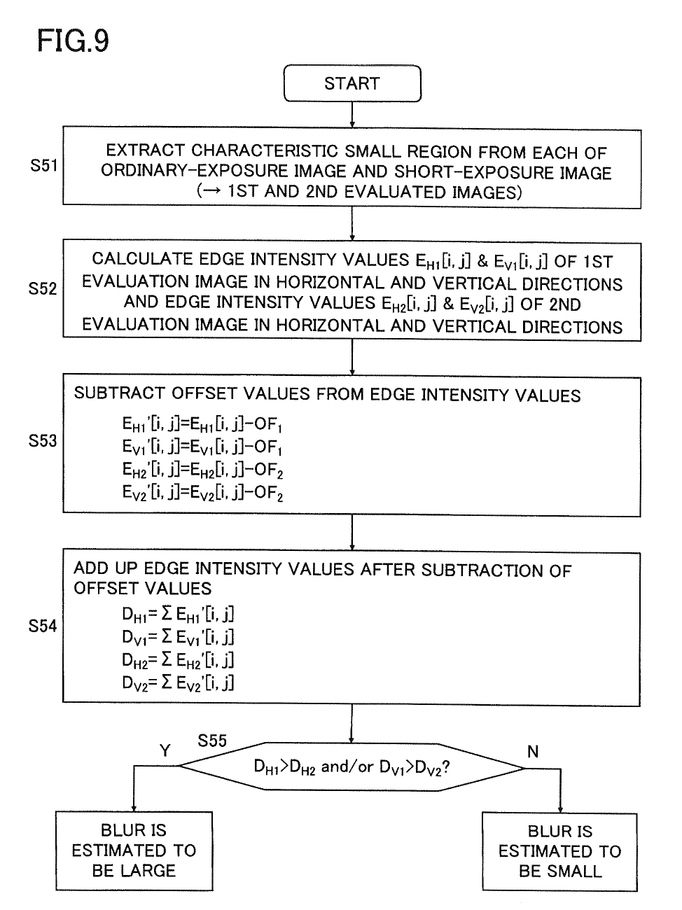

FIG. 9 is a flow chart showing the processing executed by the correction control portion 52 in FIG. 3 when the first estimation method is adopted. When the first estimation method is adopted, the correction control portion 52 executes processing in steps S51 through S55 sequentially.

First, in step S51, by use of the Harris corner detector or the like, the correction control portion 52 extracts a characteristic small region from the ordinary-exposure image, and handles the image within that small region as a first evaluated image. What a characteristic small region refers to is the same as in the description of the second embodiment.

Subsequently, a small region corresponding to the small region extracted from the ordinary-exposure image is extracted from the short-exposure image, and the image within the small region extracted from the short-exposure image is handled as a second evaluated image. The first and second evaluated images have an equal image size (an equal number of pixels in each of the horizontal and vertical directions). In a case where the displacement between the ordinary-exposure image and the short-exposure image is negligible, the small region is extracted from the short-exposure image in such a way that the center coordinates of the small region extracted from the ordinary-exposure image (its center coordinates as observed in the ordinary-exposure image) coincide with the center coordinates of the small region extracted from the short-exposure image (its center coordinates as observed in the short-exposure image). In a case where the displacement is non-negligible, a corresponding small region in the short-exposure image may be searched for by template matching or the like. Specifically, for example, the image within the small region extracted from the ordinary-exposure image is taken as a template and, by the well-known template matching, a small region most similar to that template is searched for in the short-exposure image, and the image within the thus found small region is taken as the second evaluated image.

Instead of generating a first and a second evaluated image by extraction of characteristic small regions, it is also possible to simply extract a small region located at the center of the ordinary-exposure image as a first evaluated image and a small region located at the center of the short-exposure image as a second evaluated image. Instead, it is also possible to handle the entire image of the ordinary-exposure image as a first evaluated image and the entire image of the short-exposure image as a second evaluated image.

After the setting of the first and second evaluated images, in step S52, the edge intensities of the first evaluated image in the horizontal and vertical directions are calculated, and the edge intensities of the second evaluated image in the horizontal and vertical directions are calculated. In the following description, wherever no distinction is needed between the first and second evaluated images, they are sometimes simply referred to as evaluated images collectively and one of them as an evaluated image.

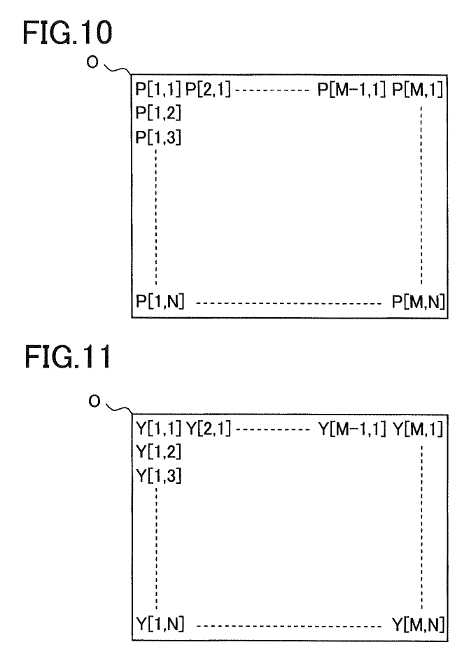

The method for edge intensity calculation in step S52 will now be described. FIG. 10 shows the pixel arrangement in an evaluated image. Suppose the number of pixels that an evaluated image has is M in the horizontal direction and N in the vertical direction. Here, M and N are each an integer of 2 or more. An evaluated image is grasped as a matrix of M×N with respect to the origin O of the evaluated image, and each of the pixels forming the evaluated image is represented by P[i, j]. Here, i is an integer between 1 to M, and represents the horizontal coordinate value of the pixel of interest on the evaluated image; j is an integer between 1 to N, and represents the vertical coordinate value of the pixel of interest on the evaluated image. The luminance value at pixel P [i, j] is represented by Y [i, j]. FIG. 11 shows luminance values expressed in the form of a matrix. As Y[i, j] increases, the luminance of the corresponding pixel P[i, j] increases.

The correction control portion 52 calculates, for each pixel, the edge intensities of the first evaluated image in the horizontal and vertical directions, and calculates, for each pixel, the edge intensities of the second evaluated image in the horizontal and vertical directions. The values that represent the calculated edge intensities are called edge intensity values. An edge intensity value is zero or positive; that is, an edge intensity value represents the magnitude (absolute value) of the corresponding edge intensity. The horizontal- and vertical-direction edge intensity values calculated with respect to pixel P[i, j] on the first evaluated image are represented by E_{H1}[i, j] and E_{V1}[i, j], and the horizontal- and vertical-direction edge intensity values calculated with respect to pixel P[i, j] on the second evaluated image are represented by E_{H2}[i, j] and E_{V2}[i, j].

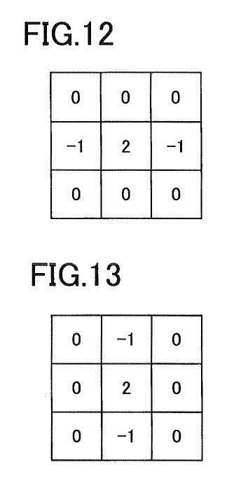

The calculation of edge intensity values is achieved by use of an edge extraction filter such as a primary differentiation filter, a secondary differentiation filter, or a Sobel filter. For example, in a case where, to calculate horizontal- and vertical-direction edge intensity values, secondary differentiation filters as shown in FIGS. 12 and 13, respectively, are used, edge intensity values E_{HI}[i, j] and E_{V1}[i, j] with respect to the first evaluated image are calculated according to the formulae E_{H1}[i, j]=|−Y[i−1, j]+2·Y[i, j]−Y[i+1, j]| and E_{V1}[i, j]=|−Y[i, j−1]+2·Y[i, j]−Y[i, j+1]|. To calculate edge intensity values with respect to a pixel located at the top, bottom, left, or right edge of the first evaluated image (for example, pixel P[1, 2]), the luminance value of a pixel located outside the first evaluated image but within the ordinary-exposure image (for example, the pixel immediately on the left of pixel P[1, 2]) can be used. Edge intensity values E_{H2}[i, j] and E_{V2}[i, j] with respect to the second evaluated image are calculated in a similar manner.

After the pixel-by-pixel calculation of edge intensity values, in step S53, the correction control portion 52 subtracts previously set offset values from the individual edge intensity values to correct them. Specifically, it calculates corrected edge intensity values E_{H1}′[i, j], E_{V1}′[i, j], E_{H2}′[i, j], and E_{V2}′[i, j] according to formulae (B-1) to (B-4) below. However, wherever subtracting an offset value OF₁ or OF₂ from an edge intensity value makes it negative, that edge intensity value is made equal to zero. For example, in a case where “E_{H1}[1,1]−OF₁<0”, E_{H1}′[1,1] is made equal to zero.

E_{H1}′[i,j]=E_{H1}[i,j]−OF₁ (B-1)

E_{V1}′[i,j]=E_{V1}[i,j]−OF₁ (B-2)

E_{H2}′[i,j]=E_{H2}[i,j]−OF₂ (B-3)

E_{V2}′[i,j]=E_{V2}[i,j]−OF₂ (B-4)

Subsequently, in step S54, the correction control portion 52 adds up the thus corrected edge intensity values according to formulae (B-5) to (B-8) below to calculate edge intensity sum values D_{H1}, D_{V1}, D_{H2}, and D_{V2}. The edge intensity sum value D_{H1} is the sum of (M×N) corrected edge intensity values E_{H1}′[i, j] (that is, the sum of all the edge intensity values E_{H1}′[i, j] in the range of 1≦i≦M and 1≦j ≦N). A similar explanation applies to edge intensity sum values D_{V1}, D_{H2} and D_{V2}.

$$\begin{matrix}{D}_{H 1} = {\sum }_{i , j} {E}_{H 1}^{′} [ i , j ] & ( B \text{-} 5 ) \\ {D}_{V 1} = {\sum }_{i , j} {E}_{V 1}^{′} [ i , j ] & ( B \text{-} 6 ) \\ {D}_{H 2} = {\sum }_{i , j} {E}_{H 2}^{′} [ i , j ] & ( B \text{-} 7 ) \\ {D}_{V 2} = {\sum }_{i , j} {E}_{V 2}^{′} [ i , j ] & ( B \text{-} 8 )\end{matrix}$$

Then, in step S55, the correction control portion 52 compares the edge intensity sum values calculated with respect to the first evaluated image with the edge intensity sum values calculated with respect to the second evaluated image and, based on the result of the comparison, estimates the degree of blur in the short-exposure image. The larger the degree of blur, the smaller the edge intensity sum values. Accordingly, in a case where, of the horizontal- and vertical-direction edge intensity sum values calculated with respect to the second evaluated image, at least one is smaller than its counterpart with respect to the first evaluated image, the degree of blur in the short-exposure image is judged to be relatively large.

Specifically, whether or not inequalities (B-9) and (B-10) below are fulfilled is evaluated and, in a case where at least one of inequalities (B-9) and (B-10) is fulfilled, the degree of blur in the short-exposure image is judged to be relatively large. In this case, it is judged that it is impractical to execute blur correction processing. By contrast, in a case where neither inequality (B-9) nor (B-10) is fulfilled, the degree of blur in the short-exposure image is judged to be relatively small. In this case, it is judged that it is practical to execute blur correction processing.

D_{H1}>D_{H2} (B-9)

D_{V1}>D_{V2} (B-10)

As will be understood from the method for calculating edge intensity sum values, the edge intensity sum values D_{H1} and D_{V1} take values commensurate with the magnitudes of blur in the first evaluated image in the horizontal and vertical directions respectively, and the edge intensity sum values D_{H2} and D_{V2} take values commensurate with the magnitudes of blur in the second evaluated image in the horizontal and vertical directions respectively. Only in a case where the magnitude of blur in the second evaluated image is smaller than that in the first evaluated image both in the horizontal and vertical directions, the correction control portion 52 judges the degree of blur in the short-exposure image to be relatively small, and thus enables blur correction processing.

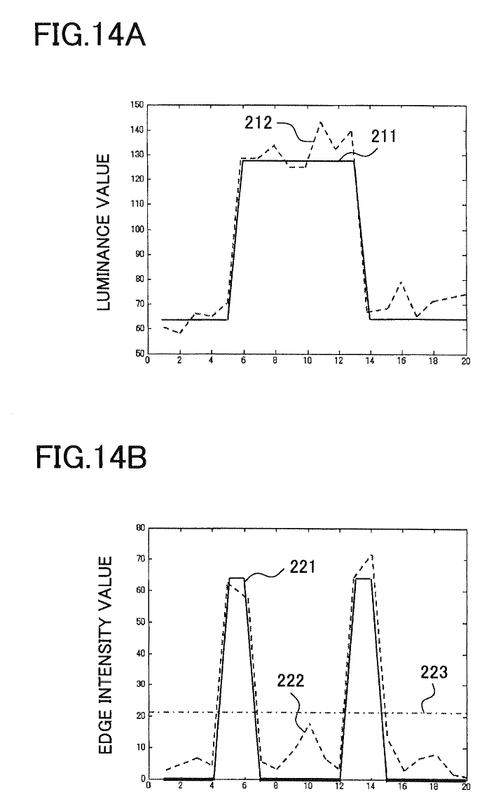

The correction of edge intensity values by use of offset values acts in such a direction as to reduce the difference in edge intensity between the first and second evaluated images resulting from the difference between the ISO sensitivity during the shooting of the ordinary-exposure image and the ISO sensitivity during the shooting of the short-exposure image. In other words, the correction acts in such a direction as to reduce the influence of the latter difference (the difference in ISO sensitivity) on the estimation of the degree of blur. The reason will now be explained with reference to FIGS. 14A and 14B.

In FIGS. 14A and 14B, solid lines 211 and 221 represent a luminance value distribution and an edge intensity value distribution, respectively, in an image free from influence of noise, and broken lines 212 and 222 represent a luminance value distribution and an edge intensity value distribution, respectively, in an image suffering influence of noise. In FIGS. 14A and 14B, attention is paid only in a one-dimensional direction and, in both of the graphs of FIGS. 14A and 14B, the horizontal axis represents pixel position. In a case where there is no influence of noise, in a part where luminance is flat, edge intensity values are zero; by contrast, in a case where there is influence of noise, even in a part where luminance is flat, some edge intensity values are non-zero. In FIG. 14B, a dash-and-dot line 223 represents the offset value OF₁ or OF₂.

Generally, since the ISO sensitivity of an ordinary-exposure image is relatively low, and accordingly the influence of noise on an ordinary-exposure image is relatively weak; on the other hand, since the ISO sensitivity of a short-exposure image is relatively high, and accordingly the influence of noise on a short-exposure image is relatively strong. Thus, an ordinary-exposure image largely corresponds to the solid lines 211 and 221, and a short-exposure image largely corresponds to the broken lines 212 and 222. If edge intensity sum values are calculated without performing correction-by-subtraction using offset values, the edge intensity sum value with respect to the short-exposure image will be greater by the increase in edge intensity attributable to noise, and thus the influence of the difference in ISO sensitivity will appear in the edge intensity sum values. It is in view of this that the above-described correction-by-subtraction using offset values is performed. Through this correction-by-subtraction, the edge intensity component having a relatively small value resulting from noise is eliminated, and it is thus possible to reduce the influence of the difference in ISO sensitivity on the estimation of the degree of blur. This results in improved accuracy of the estimation of the degree of blur.

The offset values OF₁ and OF₂ can be set previously in the manufacturing or design stages of the image shooting apparatus 1. For example, with entirely or almost no light incident on the image sensor 33, ordinary-exposure shooting and short-exposure shooting is performed to acquire two black images and, based on the edge intensity sum values with respect to the two black images, the offset values OF₁ and OF₂ can be determined. The offset values OF₁ and OF₂ may be equal values, or may be different values.

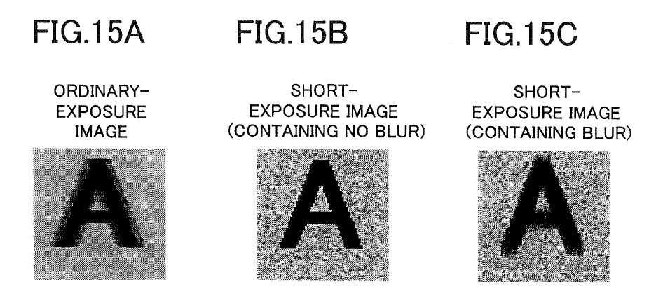

FIG. 15A shows an example of an ordinary-exposure image. The ordinary-exposure image in FIG. 15A has a relatively large degree of blur in the horizontal direction. FIGS. 15B and 15C show a first and a second example of short-exposure images. The short-exposure image in FIG. 15B has almost no blur in either of the horizontal and vertical directions. Accordingly, when the blur estimation described above is performed on the ordinary-exposure image in FIG. 15A and the short-exposure image in FIG. 15B, neither of the above inequalities (B-9) and (B-10) is fulfilled, and thus it is judged that the degree of blur in the short-exposure image is relatively small. By contrast, the short-exposure image in FIG. 15C has a relatively large degree of blur in the vertical direction. Accordingly, when the blur estimation described above is performed on the ordinary-exposure image in FIG. 15A and the short-exposure image in FIG. 15C, formula (B-10) noted above is fulfilled, and thus it is judged that the degree of blur in the short-exposure image is relatively large.

Second Estimation Method: Next, a second estimation method will be described. In the second estimation method, the degree of blur in the short-exposure image is estimated based on the amount of displacement between the ordinary-exposure image and the short-exposure image. A more specific description will now be given.

As is well known, when two images are shot at different times, a displacement resulting from motion blur (physical vibration such as camera shake) or the like may occur between the two images. In a case where the second estimation method is adopted, based on the image data of the ordinary-exposure image and the short-exposure image, the correction control portion 52 calculates the amount of displacement between the two images, and compares the magnitude of the amount of displacement with a previously set displacement threshold value. If the former is greater than the latter, the correction control portion 52 judges that the degree of blur in the short-exposure image is relatively large. In this case, blur correction processing is disabled. By contrast, if the former is smaller than the latter, the correction control portion 52 judges that the degree of blur in the short-exposure image is relatively small. In this case, blur correction processing is enabled.

The amount of displacement is a two-dimensional quantity containing a horizontal and a vertical component, and is expressed as a so-called motion vector. Needless to say, the magnitude of the amount of displacement compared with the displacement threshold value (in other words, the magnitude of the motion vector) is a one-dimensional quantity. The amount of displacement can be calculated by representative point matching or block matching.

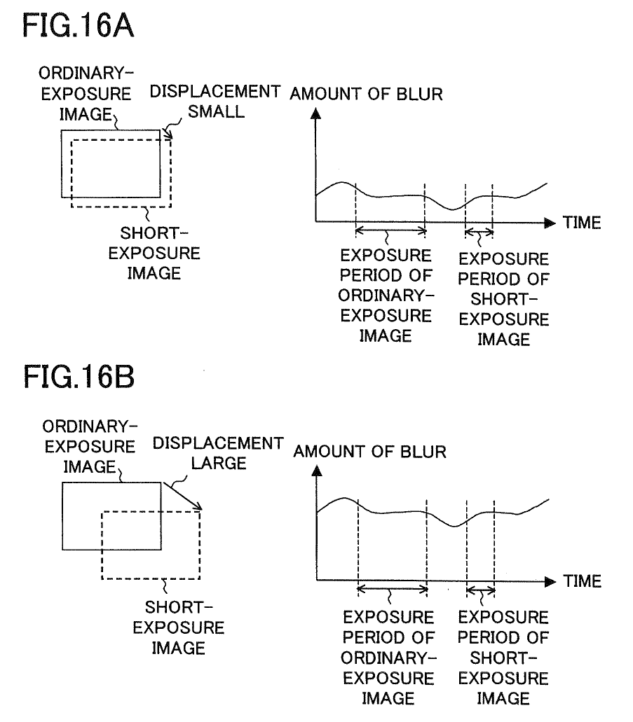

With focus placed on the amount of motion blur (physical vibration) that can act on the image shooting apparatus 1, a supplementary explanation of the second estimation method will now be given. FIG. 16A shows the appearance of the amount of motion blur in a case where the amount of displacement between the ordinary-exposure image and the short-exposure image is relatively small. The sum value of the amounts of momentary motion blur that acted during the exposure period of the ordinary-exposure image is the overall amount of motion blur with respect to the ordinary-exposure image, and the sum value of the amounts of momentary motion blur that acted during the exposure period of the short-exposure image is the overall amount of motion blur with respect to the short-exposure image. As the overall amount of motion blur with respect to the short-exposure image increases, the degree of blur in the short-exposure image increases.

Since the time taken to complete the shooting of the two images is short (for example, about 0.1 seconds), it can be assumed that the amount of motion blur that acts between the time points of the start and completion of the shooting of the two images is constant. Then the amount of displacement between the ordinary-exposure image and the short-exposure image is approximated as the sum value of the amounts of momentary motion blur that acted between the mid point of the exposure period of the ordinary-exposure image and the mid point of the exposure period of the short-exposure image. Accordingly, in a case where, as shown in FIG. 16B, the calculated amount of displacement is large, it can be estimated that the sum value of the amounts of momentary motion blur that acted during the exposure period of the short-exposure image is large as well (that is, the overall amount of motion blur with respect to the short-exposure image is large); in a case where, as shown in FIG. 16A, the calculated amount of displacement is small, it can be estimated that the sum value of the amounts of momentary motion blur that acted during the exposure period of the short-exposure image is small as well (that is, the overall amount of motion blur with respect to the short-exposure image is small).

Third Estimation Method: Next, a third estimation method will be described. In the third estimation method, the degree of blur in the short-exposure image is estimated based on an image degradation function of the ordinary-exposure image as estimated by use of the image data of the ordinary-exposure image and the short-exposure image.

The principle of the third estimation method will be described below. Observation models of the ordinary-exposure image and the short-exposure image can be expressed by formulae (C-1) and (C-2) below.

g₁=h₁*f₁+n₁ (C-1)

g₂=h₂*f₁+n₂ (C-2)

Here, g₁ and g₂ represent the ordinary-exposure image and the short-exposure image, respectively, as obtained through actual shooting, h₁ and h₂ represent the image degradation functions of the ordinary-exposure image and the short-exposure image, respectively, as obtained through actual shooting, and n₁ and n₂ represent the observation noise components contained in the ordinary-exposure image and the short-exposure image, respectively, as obtained through actual shooting. The symbol f₁ represents an ideal image neither degraded by blur nor influenced by noise. If the ordinary-exposure image and the short-exposure image are free from blur and free from influence of noise, g₁ and g₂ are equivalent to f₁. Specifically, an image degradation function is, for example, a point spread function. The asterisk (*) in formula (C-1) etc. represents convolution integral. For example, h₁*f₁ represents the convolution integral of h₁ and f₁.

An image can be expressed by a two-dimensional matrix, and therefore an image degradation function can also be expressed by a two-dimensional matrix. The properties of an image degradation function dictate that, in principle, when it is expressed in the form of a matrix, each of its elements takes a value of 0 or more but 1 or less and the total value of all its elements equals 1.

If it is assumed that the short-exposure image contains no degradation resulting from blur, an image degradation function h₁′ that minimizes the evaluation value J given by formula (C-3) below can be estimated to be the image degradation function of the ordinary-exposure image. The image degradation function h₁′ is called the estimated image degradation function. The evaluation value J is the square of the norm of (g₁−h₁′*g₂).

J=||g₁−h₁′*g₂||² (C-3)

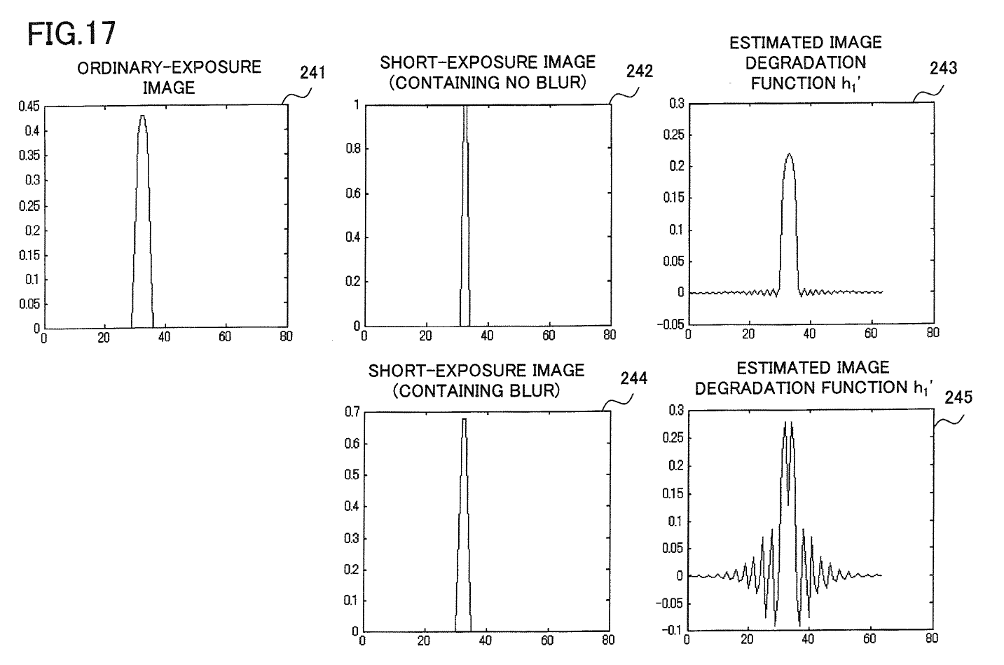

Here, in a case where the short-exposure image truly contains no blur, under the influence of observation noise, the estimated image degradation function h₁′ includes elements having negative values, but the total value of these negative values has a small value. In FIG. 17, a pixel value distribution of an ordinary-exposure image is shown by a graph 241, and a pixel value distribution of a short-exposure image in a case where it contains no blur is shown by a graph 242. The distribution of the values of elements of the estimated image degradation function h₁′ found from the two images corresponding to the graphs 241 and 242 is shown by a graph 243. In the graphs 241 to 243, and also in the graphs 244 and 245 described later, the horizontal axis corresponds to a spatial direction. In the discussion of the graphs 241 to 245, for the sake of convenience, the relevant images are each through of as a one-dimensional image. The graph 243 confirms that the total value of negative values in the estimated image degradation function h₁′ is small.

On the other hand, in a case where the short-exposure image contains blur, under the influence of the image degradation function of the short-exposure image, the estimated image degradation function h₁′ is, as given by formula (C-4) below, close to the convolution integral of the true image degradation function of the ordinary-exposure image and the inverse function h₂⁻¹ of the image degradation function of the short-exposure image. In a case where the short-exposure image contains blur, the inverse function h₂⁻¹ includes elements having negative values. Thus, as compared with in a case where the short-exposure image contains no blur, the estimated image degradation function h₁′ includes a relatively large number of elements having negative values, and the absolute values of those values are relatively large. Thus, the magnitude of the total value of negative values included in the estimated image degradation function h₁′ is greater in a case where the short-exposure image contains blur than in a case where the short-exposure image contains no blur.

h₁′←h₁*h₂⁻¹ (C-4)

In FIG. 17, a graph 244 shows a pixel value distribution of a short-exposure image in a case where it contains blur, and a graph 245 shows the distribution of the values of elements of the estimated image degradation function h₁′ found from the ordinary-exposure image and the short-exposure image corresponding to the graphs 241 and 244.

Based on the principle described above, in practice, processing proceeds as follows. First, based on the image data of the ordinary-exposure image and the short-exposure image, the correction control portion 52 derives the estimated image degradation function h₁′ that minimizes the evaluation value J. The derivation here can be achieved by any well-known method. In practice, by use of the method mentioned in the description of the first estimation method, from the ordinary-exposure image and the short-exposure image, a first and a second evaluated image are extracted (see step S51 in FIG. 9); then the extracted first and second evaluated images are grasped as g₁ and g₂ respectively, and the estimated image degradation function h₁′ for minimizing the evaluation value J given by formula (C-3) above is derived. As described above, the estimated image degradation function h₁′ is expressed as a two-dimensional matrix.

The correction control portion 52 refers to the values of the individual elements (all the elements) of the estimated image degradation function h₁′ as expressed in the form of a matrix, and extracts, out of the values referred to, those falling outside a prescribed numerical range. In the case currently being discussed, the upper limit of the numerical range is set at a value sufficiently greater than 1, and the lower limit is set at 0. Thus, out of the values referred to, only those having negative values are extracted. The correction control portion 52 adds up all the negative values thus extracted to find their total value, and compares the absolute value of the total value with a previously set threshold value R_{TH}. Then, if the former is greater than the latter (R_{TH}), the correction control portion 52 judges that the degree of blur in the short-exposure image is relatively large. In this case, blur correction processing is disabled. By contrast, if the former is smaller than the latter (R_{TH}), the correction control portion 52 judges that the degree of blur in the short-exposure image is relatively small. In this case, blur correction processing is enabled. With the influence of noise taken into consideration, the threshold value R_{TH} is set at, for example, about 0.1.

### Fourth Embodiment

Next, a fourth embodiment of the invention will be described. The fourth embodiment deals with methods for blur correction processing based on a correction target image and a consulted image which can be applied to the first to third embodiments. That is, these methods can be used for the blur correction processing in step S9 shown in FIGS. 4, 7, and 8. It is assumed that the correction target image and the consulted image have an equal image size. In the fourth embodiment, the entire image of the correction target image, the entire image of the consulted image, and the entire image of a blur-corrected image are represented by the symbols Lw, Rw, and Qw respectively.

Presented below as examples of methods for blur correction processing will be a first to a fourth correction method. The first, second, and third correction methods are ones employing image restoration processing, image merging processing, and image sharpening processing respectively. The fourth correction method also is one exploiting image merging processing, but differs in implementation from the second correction method (the details will be clarified in the description given later). It is assumed that what is referred to simply as “the memory” in the following description is the internal memory 14 (see FIG. 1).

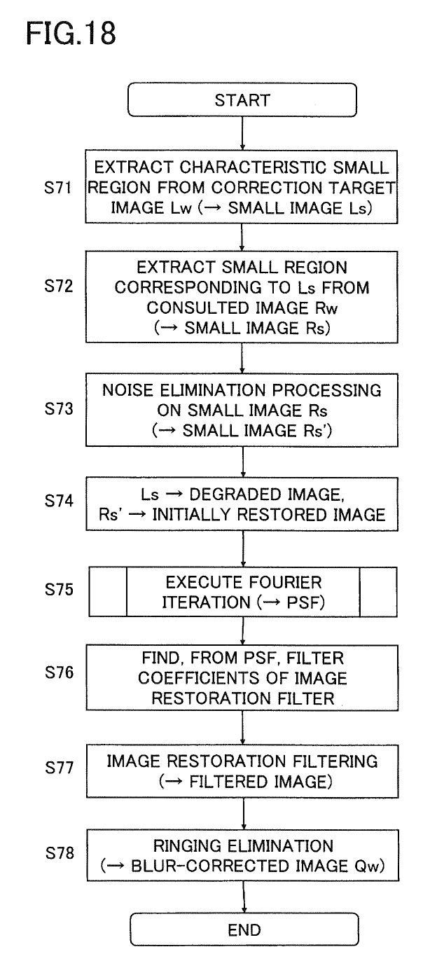

First Correction Method: With reference to FIG. 18, a first correction method will be described. FIG. 18 is a flow chart showing the flow of blur correction processing according to the first correction method.

First, in step S71, a characteristic small region is extracted from the correction target image Lw, and the image within the thus extracted small region is, as a small image Ls, stored in the memory. For example, by use of the Harris corner detector, a 128×128-pixel small region is extracted as a characteristic small region. What a characteristic small region refers to is the same as in the description of the second embodiment.

Next, in step S72, a small region corresponding to the small region extracted from the correction target image Lw is extracted from the consulted image Rw, and the image within the small region extracted from the consulted image Rw is, as a small image Rs, stored in the memory. The small image Ls and the small image Rs have an equal image size. In a case where the displacement between the correction target image Lw and the consulted image Rw is negligible, the small region is extracted from the short-exposure image Rw in such a way that the center coordinates of the small image Ls extracted from the correction target image Lw (its center coordinates as observed in the correction target image Lw) are equal to the center coordinates of the small image Rs extracted from the consulted image Rw (its center coordinates as observed in the consulted image Rw). In a case where the displacement is non-negligible, a corresponding small region may be searched for by template matching or the like. Specifically, for example, the small image Ls is taken as a template and, by the well-known template matching, a small region most similar to that template is searched for in the consulted image Rw, and the image within the thus found small region is taken as the small image Rs.

Since the exposure time of the consulted image Rw is relatively short and its ISO sensitivity is relatively high, the S/N ratio of the small image Rs is relatively low. Thus, in step S73, noise elimination processing using a median filter or the like is applied to the small image Rs. The small image Rs having undergone the noise elimination processing is, as a small image Rs′, stored in the memory. The noise elimination processing here may be omitted.

The thus obtained small images Ls and Rs′ are handled as a degraded (convolved) image and an initially restored (deconvolved) image respectively (step S74), and then, in step S75, Fourier iteration is executed to find an image degradation function representing the condition of the degradation of the small image Ls resulting from blur.

To execute Fourier iteration, an initial restored image (the initial value of a restored image) needs to be given, and this initial restored image is called the initially restored image.

To be found as the image degradation function is a point spread function (hereinafter called a PSF). Since motion blur uniformly degrades (convolves) an entire image, a PSF found for the small image Ls can be used as a PSF for the entire correction target image Lw.

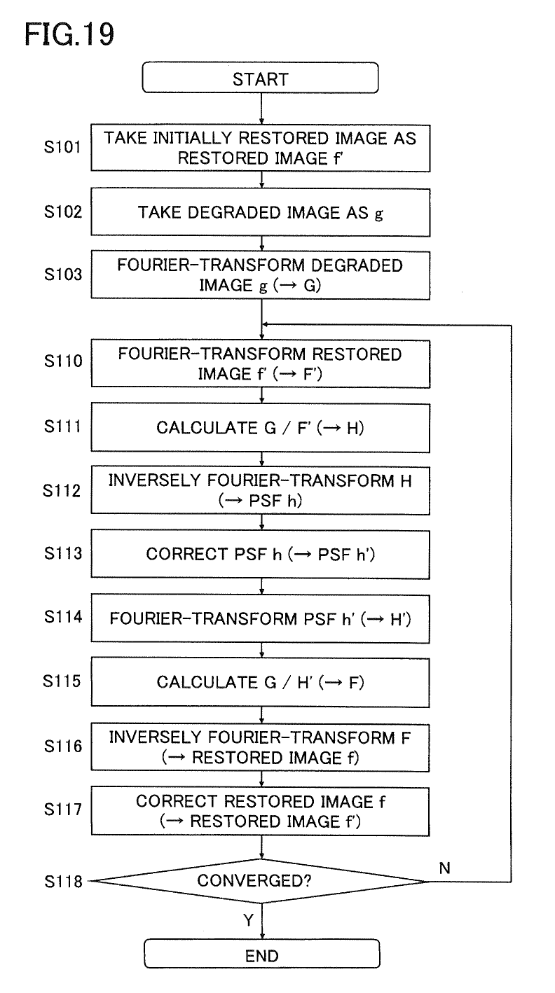

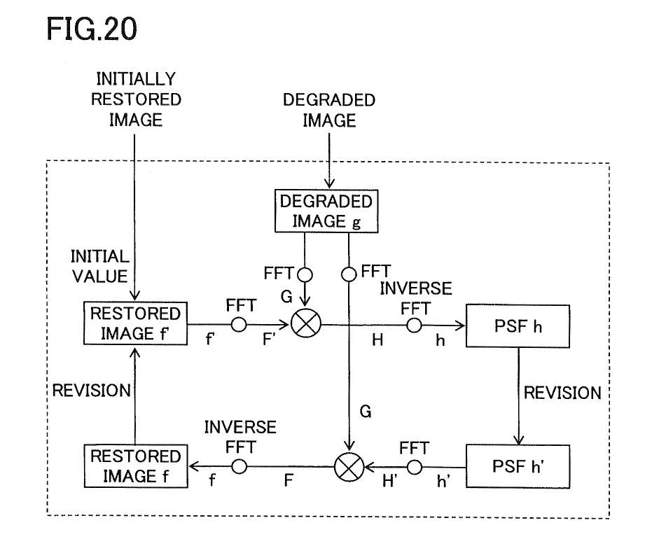

Fourier iteration is a method for restoring, from a degraded image—an image suffering degradation, a restored image—an image having the degradation eliminated or reduced (see, for example, the following publication: G. R. Ayers and J. C. Dainty, “Iterative blind deconvolution method and its applications”, OPTICS LETTERS, 1988, Vol. 13, No. 7, pp. 547-549). Now, Fourier iteration will be described in detail with reference to FIGS. 19 and 20. FIG. 19 is a detailed flow chart of the processing in step S75 in FIG. 18. FIG. 20 is a block diagram of the blocks that execute Fourier iteration which are provided within the blur correction processing portion 53 in FIG. 3.

First, in step S101, the restored image is represented by f′, and the initially restored image is taken as the restored image f′. That is, as the initial restored image f′, the small image Rs′ is used. Next, in step S102, the degraded image (the small image Ls) is taken as g. Then, the degraded image g is Fourier-transformed, and the result is, as G, stored in the memory (step S103). For example, in a case where the initially restored image and the degraded image have an image size of 128×128 pixels, f′ and g are expressed as matrices each of an 128×128 array.

Next, in step S110, the restored image f′ is Fourier-transformed to find F′, and then, in step S111, H is calculated according to formula (D-1) below. H corresponds to the Fourier-transformed result of the PSF. In formula (D-1), F′* is the conjugate complex matrix of F′, and α is a constant.

$$H = \frac{G \cdot {F}^{′ *}}{{\vert {F}^{′} \vert}^{2} + α} \qquad ( D \text{-} 1 )$$

Next, in step S112, H is inversely Fourier-transformed to obtain the PSF. The obtained PSF is taken as h. Next, in step S113, the PSF h is revised according to the restricting condition given by formula (D-2a) below, and the result is further revised according to the restricting condition given by formula (D-2b) below.

$$\begin{matrix}h ( x , y ) = \{ \begin{matrix}1 \text{:} & h ( x , y ) > 1 \\ h ( x , y ) \text{:} & 0 \leq h ( x , y ) \leq 1 \\ 0 \text{:} & h ( x , y ) < 0\end{matrix} & ( D \text{-} 2 a ) \\ \sum h ( x , y ) = 1 & ( D \text{-} 2 b )\end{matrix}$$

The PSF h is expressed as a two-dimensional matrix, of which the elements are represented by h(x, y). Each element of the PSF should inherently take a value of 0 or more but 1 or less. Accordingly, in step S113, whether or not each element of the PSF is 0 or more but 1 or less is checked and, while any element that is 0 or more but 1 or less is left intact, any element more than 1 is revised to be equal to 1 and any element less than 0 is revised to be equal to 0. This is the revision according to the restricting condition given by formula (D-2a). Then, the thus revised PSF is normalized such that the sum of all its elements equals 1. This normalization is the revision according to the restricting condition given by formula (D-2b).

The PSF as revised according to formulae (D-2a) and (D-2b) is taken as h′.

Next, in step S114, the PSF h′ is Fourier-transformed to find H′, and then, in step S115, F is calculated according to formula (D-3) below. F corresponds to the Fourier-transformed result of the restored image f. In formula (D-3), H′* is the conjugate complex matrix of H′, and β is a constant.

$$F = \frac{G \cdot {H}^{′ *}}{{\vert {H}^{′} \vert}^{2} + β} \qquad ( D \text{-} 3 )$$

Next, in step S116, F is inversely Fourier-transformed to obtain the restored image. The thus obtained restored image is taken as f. Next, in step S117, the restored image f is revised according to the restricting condition given by formula (D-4) below, and the revised restored image is newly taken as f′.

$$f ( x , y ) = \{ \begin{matrix}255 \text{:} & f ( x , y ) > 255 \\ f ( x , y ) : & 0 \leq f ( x , y ) \leq 255 \\ 0 \text{:} & f ( x , y ) < 0\end{matrix} \qquad ( D \text{-} 4 )$$

The restored image f is expressed as a two-dimensional matrix, of which the elements are represented by f(x, y). Assume here that the value of each pixel of the degraded image and the restored image is represented as a digital value of 0 to 255. Then, each element of the matrix representing the restored image f (that is, the value of each pixel) should inherently take a value of 0 or more but 255 or less. Accordingly, in step S117, whether or not each element of the matrix representing the restored image f is 0 or more but 255 or less is checked and, while any element that is 0 or more but 255 or less is left intact, any element more than 255 is revised to be equal to 255 and any element less than 0 is revised to be equal to 0. This is the revision according to the restricting condition given by formula (D-4).

Next, in step S118, whether or not a convergence condition is fulfilled is checked and thereby whether or not the iteration has converged is checked.

For example, the absolute value of the difference between the newest F′ and the immediately previous F′ is used as an index for the convergence check. If this index is equal to or less than a predetermined threshold value, it is judged that the convergence condition is fulfilled; otherwise, it is judged that the convergence condition is not fulfilled.

If the convergence condition is fulfilled, the newest H′ is inversely Fourier-transformed, and the result is taken as the definitive PSF. That is, the inversely Fourier-transformed result of the newest H′ is the PSF eventually found in step S75 in FIG. 18. If the convergence condition is not fulfilled, a return is made to step S110 to repeat the processing in steps S110 through S118. As the processing in steps S110 through S118 is repeated, the functions f′, F′, H, h, h′, H′, F, and f (see FIG. 20) are updated to be the newest one after another.

As the index for the convergence check, any other index may be used. For example, the absolute value of the difference between the newest H′ and the immediately previous H′ may be used as an index for the convergence check with reference to which to check whether or not the above-mentioned convergence condition is fulfilled. Instead, the amount of revision made in step S113 according to formulae (D-2a) and (D-2b) above, or the amount of revision made in step S117 according to formula (D-4) above, may be used as the index for the convergence check with reference to which to check whether or not the above-mentioned convergence condition is fulfilled. This is because, as the iteration converges, those amounts of revision decrease.

If the number of times of repetition of the loop processing in steps S110 through S118 has reached a predetermined number, it may be judged that convergence is impossible and the processing may be ended without calculating the definitive PSF. In this case, the correction target image Lw is not corrected.

Back in FIG. 18, after the PSF is calculated in step S75, an advance is made to step S76. In step S76, the elements of the inverse matrix of the PSF calculated in step S75 are found as the individual filter coefficients of the image restoration filter. This image restoration filter is a filter for obtaining the restored image from the degraded image. In practice, the elements of the matrix expressed by formula (D-5) below, which corresponds to part of the right side of formula (D-3) above, correspond to the individual filter coefficients of the image restoration filter, and therefore an intermediary result of the Fourier iteration calculation in step S75 can be used intact. What should be noted here is that H′* and H′ in formula (D-5) are H′* and H′ as obtained immediately before the fulfillment of the convergence condition in step S118 (that is, H′* and H′ as definitively obtained).

$$\frac{{H}^{′ *}}{{\vert {H}^{′} \vert}^{2} + β} \qquad ( D \text{-} 5 )$$

After the individual filter coefficients of the image restoration filter are found in step S76, an advance is made to step S77, where the entire correction target image Lw is subjected to filtering (spatial filtering) by use of the image restoration filter. Specifically, the image restoration filter having the calculated filter coefficients is applied to the individual pixels of the correction target image Lw so that the correction target image Lw is filtered. As a result, a filtered image in which the blur contained in the correction target image Lw has been reduced is generated. Although the size of the image restoration filter is smaller than the image size of the correction target image Lw, since motion blur is considered to uniformly degrade an entire image, applying the image restoration filter to the entire correction target image Lw reduces blur in the entire correction target image Lw.

The filtered image may contain ringing ascribable to the filtering, and thus then, in step S78, the filtered image is subjected to ringing elimination to eliminate the ringing and thereby generate a definitive blur-corrected image Qw. Since methods for eliminating ringing are well known, no detailed description will be given in this respect. One such method that can be used here is disclosed in, for example, JP-A-2006-129236.

In the blur-corrected image Qw, the blur contained in the correction target image Lw has been reduced, and the ringing ascribable to the filtering has also been reduced. Since the filtered image already has the blur eliminated, it can be regarded as the blur-corrected image Qw.

Since the amount of blur contained in the consulted image Rw is small, its edge component is close to that of an ideal image containing no blur. Thus, as described above, an image obtained from the consulted image Rw is taken as the initially restored image for Fourier iteration.

As the loop processing of Fourier iteration is repeated, the restored image (f) grows closer and closer to an image containing minimal blur. Here, since the initially restored image itself is already close to an image containing no blur, convergence takes less time than in cases in which, as conventionally practiced, a random image or a degraded image is taken as the initially restored image (at shortest, convergence is achieved with a single loop). Thus, the processing time for creating a PSF and the filter coefficients of an image restoration filter needed for blur correction processing is reduced. Moreover, whereas if the initially restored image is remote from the image to which it should converge, it is highly likely that it will converge to a local solution (an image different from the image to which it should converge), setting the initially restored image as described above makes it less likely that it will converge to a local solution (that is, makes failure of motion blur correction less likely).

Moreover, based on the belief that motion blur uniformly degrades an entire image, a small region is extracted from a given image, then a PSF and the filter coefficients of an image restoration filter are created from the image data in the small region, and then they are applied to the entire image. This helps reduce the amount of calculation needed, and thus helps reduce the processing time for creating a PSF and the filter coefficients of an image restoration filter and the processing time for motion blur correction. Needless to say, also expected is a reduction in the scale of the circuitry needed and hence in costs.

Here, as described above, a characteristic small region containing a large edge component is automatically extracted. An increase in the edge component in the image based on which to calculate a PSF signifies an increase in the proportion of the signal component to the noise component. Thus, extracting a characteristic small region helps reduce the influence of noise, and thus makes more accurate detection of a PSF possible.

In the processing shown in FIG. 19, the degraded image g and the restored image f′ in a spatial domain are converted by a Fourier transform into a frequency domain, and thereby the function G representing the degraded image g in the frequency domain and the function F′ representing the restored image f′ in the frequency domain are found (needless to say, the frequency domain here is a two-dimensional frequency domain). From the thus found functions G and F′, a function H representing a PSF in the frequency domain is found, and this function H is then converted by an inverse Fourier transform to a function in the spatial domain, namely a PSF h. This PSF h is then revised according to a predetermined restricting condition to find a revised PSF h′. The revision of the PSF here will henceforth be called the “first type of revision”.

The PSF h′ is then converted by a Fourier transform back into the frequency domain to find a function H′, and from the functions H′ and G, a function F is found, which represents the restored image in the frequency domain. This function F is then converted by inverse Fourier transform to find a restored image f on the spatial domain. This restored image f is then revised according to a predetermined restricting condition to find a revised restored image f′. The revision of the restored image here will henceforth be called the “second type of revision”.

In the example described above, as mentioned in the course of its description, thereafter, until the convergence condition is fulfilled in step S118 in FIG. 19, the above processing is repeated by using the revised restored image f′; moreover, in view of the fact that, as the iteration converges, the amounts of revision decrease, the check of whether or not the convergence condition is fulfilled may be made based on the amount of revision made in step S113, which corresponds to the first type of revision, or the amount of revision made in step S117, which corresponds to the second type of revision. In a case where the check is made based on the amount of revision, a reference amount of revision is set beforehand, and the amount of revision in step S113 or S117 is compared with it so that, if the former is smaller than the latter (the reference amount of revision), it is judged that the convergence condition is fulfilled. Here, when the reference amount of revision is set sufficiently large, the processing in steps S110 through S117 is not repeated. That is, in that case, the PSF h′ obtained through a single session of the first type of revision is taken as the definitive PSF that is to be found in step S75 in FIG. 18. In this way, even when the processing shown in FIG. 19 is adopted, the first and second types of revision are not always repeated.

An increase in the number of times of repetition of the first and second types of revision contributes to an increase in the accuracy of the definitively found PSF. In this example, however, the initially restored image itself is already close to an image containing no motion blur, and therefore the accuracy of the PSF h′ obtained through a single session of the first type of revision is high enough to be acceptable in practical terms. In view of this, the check itself in step S118 may be omitted. In that case, the PSF h′ obtained through the processing in step S113 performed once is taken as the definitive PSF to be found in step S75 in FIG. 18, and thus, from the function H′ found through the processing in step S114 performed once, the individual filter coefficients of the image restoration filter to be found in step S76 in FIG. 18 are found. Thus, in a case where the processing in step S118 is omitted, the processing in steps S115 through S117 are also omitted.

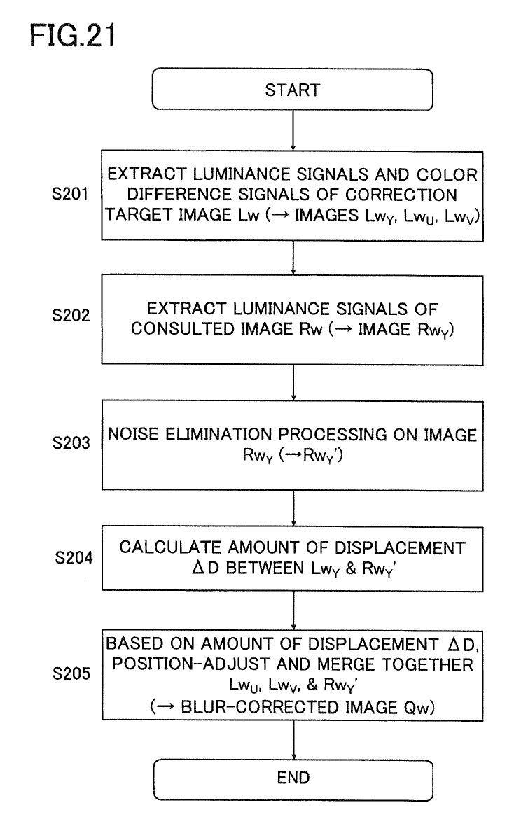

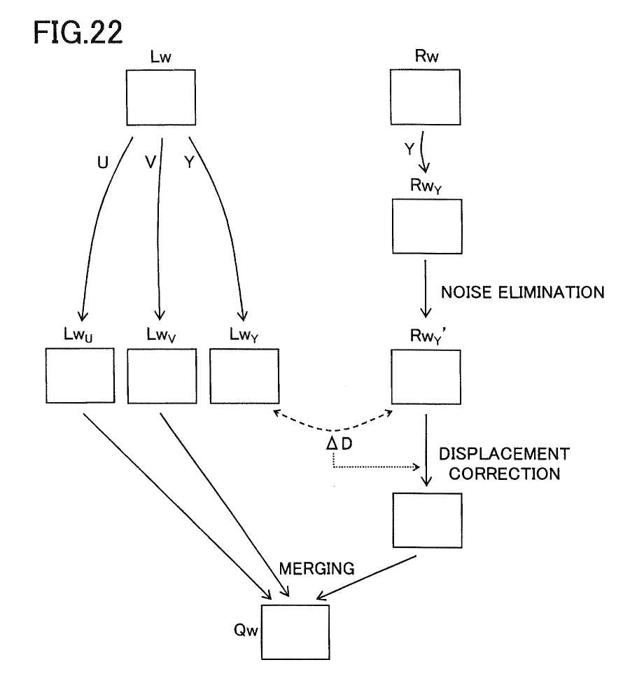

Second Correction Method: Next, with reference to FIGS. 21 and 22, a second correction method will be described. FIG. 21 is a flow chart showing the flow of blur correction processing according to the second correction method. FIG. 22 is a conceptual diagram showing the flow of this blur correction processing.

The image obtained by shooting by the image-sensing portion 11 is a color image that contains information related to luminance and information related to color. Accordingly, the pixel signal of each of the pixels forming the correction target image Lw is composed of a luminance signal representing the luminance of the pixel and a chrominance signal representing the color of the pixel. Suppose here that the pixel signal of each pixel is expressed in the YUV format. In this case, the chrominance signal is composed of two color difference signals U and V. Thus, the pixel signal of each of the pixels forming the correction target image Lw is composed of a luminance signal Y representing the luminance of the pixel and two color difference signals U and V representing the color of the pixel.

Then, as shown in FIG. 22, the correction target image Lw can be decomposed into an image Lw_{Y} containing luminance signals Y alone as pixel signals, an image Lw_{U} containing color difference signals U alone as pixel signals, and an image Lw_{V} containing color difference signals V alone as pixel signals. Likewise, the consulted image Rw can be decomposed into an image Rw_{Y} containing luminance signals Y alone as pixel signals, an image Rw_{U} containing color difference signals U alone as pixel signals, and an image Rw_{V} containing color difference signals V alone as pixel signals (only the image Rw_{Y} is shown in FIG. 22).

In step S201 in FIG. 21, first, the luminance signals and color difference signals of the correction target image Lw are extracted to generate images Lw_{Y}, Lw_{U}, and Lw_{V}. Subsequently, in step S202, the luminance signals of the consulted image Rw are extracted to generate an image Rw_{Y}.

Since the exposure time of the consulted image Rw is relatively short and its ISO sensitivity is relatively high, the image Rw_{Y} has a relatively low S/N ratio. Accordingly, in step S203, noise elimination processing using a median filter or the like is applied to the image Rw_{Y}. The image Rw_{Y} having undergone the noise elimination processing is, as an image Rw_{Y}′, stored in the memory. This noise elimination processing may be omitted.

Then, in step S204, the pixel signals of the image Lw_{Y} are compared with those of the image Rw_{Y}′ to calculate the amount of displacement ΔD between the images Lw_{Y} and Rw_{Y}′. The amount of displacement ΔD is a two-dimensional quantity containing a horizontal and a vertical component, and is expressed as a so-called motion vector. The amount of displacement ΔD can be calculated by the well-known representative point matching or template matching. For example, the image within a small region extracted from the image Lw_{Y} is taken as a template and, by template matching, a small region most similar to the template is searched for in the image Rw_{Y}′. Then, the amount of displacement between the position of the small region found as a result (its position in the image Rw_{Y}′) and the position of the small region extracted from the image Lw_{Y} (its position in the image Lw_{Y}) is calculated as the amount of displacement ΔD. Here, it is preferable that the small region extracted from the image Lw_{Y} be a characteristic small region as described previously.

With the image Lw_{Y} taken as the datum, the amount of displacement ΔD represents the amount of displacement of the image Rw_{Y}′ relative to the image Lw_{Y}. The image Rw_{Y}′ is regarded as an image displaced by a distance corresponding to the amount of displacement ΔD from the image Lw_{Y}. Thus, in step S205, the image Rw_{Y}′ is subjected to coordinate conversion (such as affine transform) such that the amount of displacement ΔD is canceled, and thereby the displacement of the image Rw_{Y}′ is corrected. As a result of the correction of the displacement, the pixel at coordinates (x+ΔDx, y+ΔDy) in the image Rw_{Y}′ before that is converted to the pixel at coordinate (x, y). ΔDx and ΔDy are a horizontal and a vertical component, respectively, of the ΔD.

In step S205, the images Lw_{U} and Lw_{V} and the displacement-corrected image Rw_{Y}′ are merged together, and the image obtained as a result is outputted as a blur-corrected image Qw. The pixel signals of the pixel located at coordinates (x, y) in the blur-corrected image Qw are composed of the pixel signal of the pixel at coordinates (x, y) in the images Lw_{U}, the pixel signal of the pixel at coordinates (x, y) in the images Lw_{V}, and the pixel signal of the pixel at coordinates (x, y) in the displacement-corrected image Rw_{Y}′.

In a color image, what appears to be blur is caused mainly by blur in luminance. Thus, if the edge component of luminance is close to that in an ideal image containing no blur, the observer perceives little blur. Accordingly, in this correction method, the luminance signal of the consulted image Rw, which contains a relatively small amount of blur, is merged with the chrominance signal of the correction target image Lw, and thereby apparent motion blur correction is achieved. With this method, although false colors appear near edges, it is possible to generate an image with apparently little blur at low calculation cost.

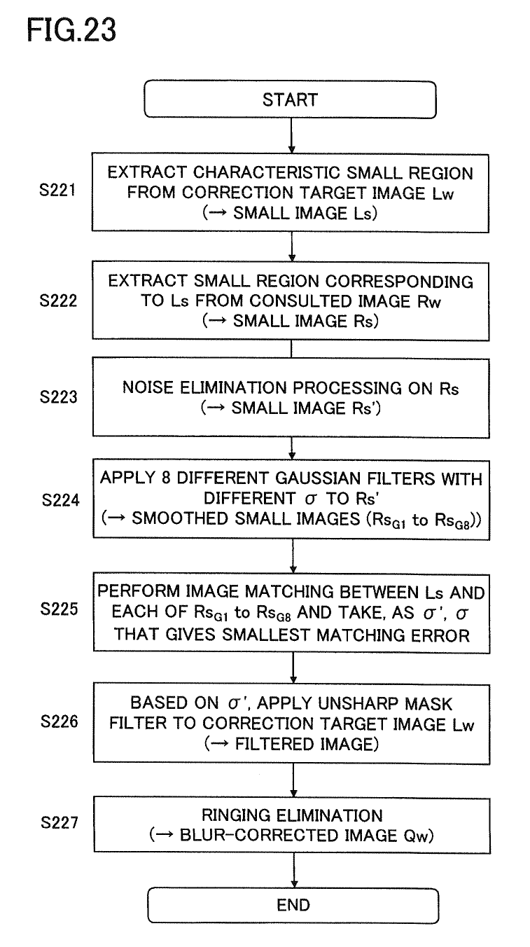

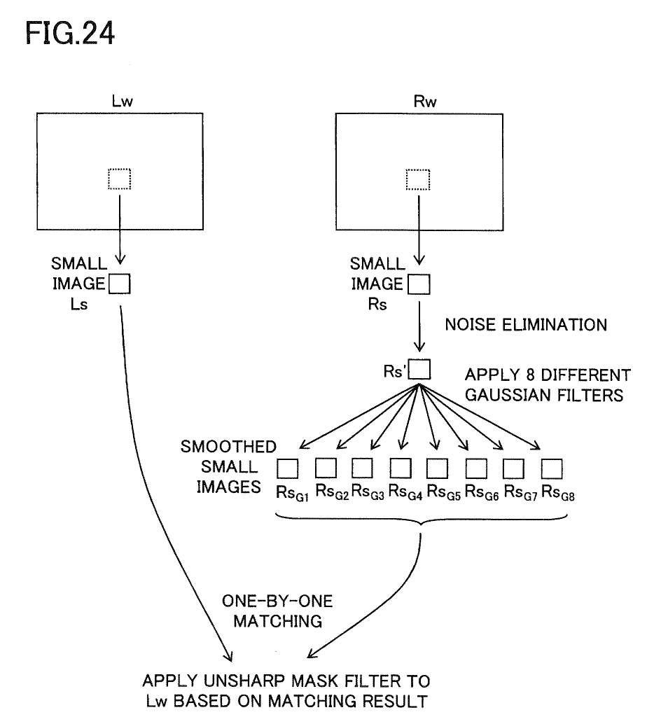

Third Correction Method: Next, with reference to FIGS. 23 and 24, a third correction method will be described. FIG. 23 is a flow chart showing the flow of blur correction processing according to the third correction method. FIG. 24 is a conceptual diagram showing the flow of this blur correction processing.

First, in step S221, a characteristic small region is extracted from the correction target image Lw to generate a small image Ls; then, in step S222, a small region corresponding to the small image Ls is extracted from the consulted image Rw to generate a small image Rs. The processing in these steps S221 and S222 are the same as that in steps S71 and S72 in FIG. 18. Subsequently, in step S223, noise elimination processing using a median filter or the like is applied to the small image Rs. The small image Rs having undergone the noise elimination processing is, as a small image Rs′, stored in the memory. This noise elimination processing may be omitted.

Next, in step S224, the small image Rs′ is filtered with eight smoothing filters that are different from one another, to generate eight smoothed small images Rs_{G1}, Rs_{G2}, . . . , Rs_{G8} that are smoothed to different degrees. Suppose now that used as the eight smoothing filters are eight Gaussian filters. The dispersion of the Gaussian distribution represented by each Gaussian filter is represented by σ².

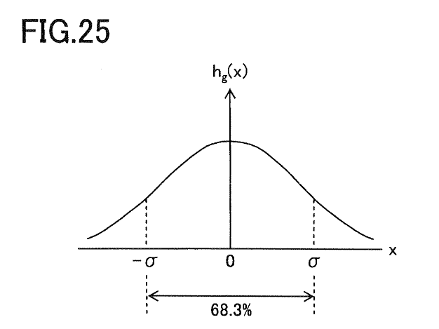

With attention focused on a one-dimensional image, when the position of a pixel in this one-dimensional image is represented by x, then, it is generally known, the Gaussian distribution of which the average is 0 and of which the dispersion is σ² is represented by formula (E-1) below (see FIG. 25). When this Gaussian distribution is applied to a Gaussian filter, the individual filter coefficients of the Gaussian filter are represented by h_{g}(x). That is, when the Gaussian filter is applied to the pixel at position 0, the filter coefficient at position x is represented by h_{g}(x). In other words, the factor of contribution, to the pixel value at position 0 after the filtering with the Gaussian filter, of the pixel value at position x before the filtering is represented by h_{g}(x).

$${h}_{g} ( x ) = \frac{1}{\sqrt{2 π} σ} exp ( - \frac{{x}^{2}}{2 {σ}^{2}} ) \qquad ( E \text{-} 1 )$$

When this way of thinking is expanded to a two-dimensional image and the position of a pixel in the two-dimensional image is represented by (x, y), the two-dimensional Gaussian distribution is represented by formula (E-2) below. Here, x and y represent the coordinates in the horizontal and vertical directions respectively. When this two-dimensional Gaussian distribution is applied to a Gaussian filter, the individual filter coefficients of the Gaussian filter are represented by h_{g}(x, y); when the Gaussian filter is applied to the pixel at position (0, 0), the filter coefficient at position (x, y) is represented by h_{g}(x, y). That is, the factor of contribution, to the pixel value at position (0, 0) after the filtering with the Gaussian filter, of the pixel value at position (x, y) before the filtering is represented by h_{g}(x, y).

$${h}_{g} ( x , y ) = \frac{1}{2 {πσ}^{2}} exp ( - \frac{{x}^{2} + {y}^{2}}{2 {σ}^{2}} ) \qquad ( E \text{-} 2 )$$

Assume that, used as the eight Gaussian filters in step S224 are those with σ=1, 3, 5, 7, 9, 11, 13, and 15. Subsequently, in step S225, image matching is performed between the small image Ls and each of the smoothed small images Rs_{G1} to Rs_{G8} to identify, of all the smoothed small images Rs_{G1} to Rs_{G8,} the one that exhibits the smallest matching error (that is, the one that exhibits the highest correlation with the small image Ls).

Now, with attention focused on the smoothed small image Rs_{G1}, a brief description will be given of how the matching error (matching residue) between the small image Ls and the smoothed small image Rs_{G1} is calculated. Assume that the small image Ls and the smoothed small image Rs_{G1} has an equal image size, and that their numbers of pixels in the horizontal and vertical directions are M_{N} and N_{N} respectively (M_{N} and N_{N} are each an integer of 2 or more). The pixel value of the pixel at position (x, y) in the small image Ls are represented by V_{Ls}(x, y), and the pixel value of the pixel at position (x, y) in the smoothed small image Rs_{G1} are represented by V_{Rs}(x, y) (here, x and y are integers fulfilling 0≦x≦M_{N}−1 and 0 ≦y≦N_{N}−1). Then, R_{SAD}, which represents the SAD (sum of absolute differences) between the matched (compared) images, is calculated according to formula (E-3) below, and R_{SSD}, which represents the SSD (sum of square differences) between the matched images, is calculated according to (E-4) below.

$$\begin{matrix}{R}_{SAD} = {\sum }_{y = 0}^{{N}_{N} - 1} {\sum }_{x = 0}^{{M}_{N} - 1} \vert {V}_{Ls} ( x , y ) - {V}_{Rs} ( x , y ) \vert & ( E \text{-} 3 ) \\ {R}_{SSD} = {\sum }_{y = 0}^{{N}_{N} - 1} {\sum }_{x = 0}^{{M}_{N} - 1} {\{ {V}_{Ls} ( x , y ) - {V}_{Rs} ( x , y ) \}}^{2} & ( E \text{-} 4 )\end{matrix}$$

R_{SAD} or R_{SSD} thus calculated is taken as the matching error between the small image Ls and the smoothed small image Rs_{G1}. Likewise, the matching error between the small image Ls and each of the smoothed small images Rs_{G2} to Rs_{G8} is found. Then, the smoothed small image that exhibits the smallest matching error is identified. Suppose now that the smoothed small image Rs_{G3} corresponding to a σ=5 is identified. Then, in step S225, σ that corresponds to the smoothed small image Rs_{G3} is taken as σ′; specifically, σ′ is given a value of 5.

Subsequently, in step S226, with the Gaussian blur represented by σ′ taken as the image degradation function representing how the correction target image Lw is degraded (convolved), the correction target image Lw is subjected to restoration (elimination of degradation).

Specifically, in step S226, based on σ′, an unsharp mask filter is applied to the entire correction target image Lw to eliminate its blur. The image before the application of the unsharp mask filter is referred to as the input image I_{INPUT}, and the image after the application of the unsharp mask filter is referred to as the output image I_{OUTPUT}. The unsharp mask filter involves the following processing. First, as the unsharp filter, the Gaussian filter of σ′ (that is, the Gaussian filter with σ=5) is adopted, and the input image I_{INPUT} is filtered with the Gaussian filter of σ′ to generate a blurred image I_{BLUR}. Next, the individual pixel values of the blurred image I_{BLUR} are subtracted from the individual pixel values of the input image I_{INPUT} to generate a differential image I_{DELTA} between the input image I_{INPUT} and the blurred image I_{BLUR}. Lastly, the individual pixel values of the differential image I_{DELTA} are added to the individual pixel values of the input image I_{INPUT}, and the image obtained as a result is taken as the output image I_{OUTPUT}. The relationship between the input image I_{INPUT} and the output image I_{OUTPUT} is expressed by formula (E-5) below. In formula (E-5), (I_{INPUT}·Gauss) represents the result of the filtering of the input image I_{INPUT} with the Gaussian filter of σ′.

$$\begin{matrix}{I}_{OUTPUT} = {I}_{INPUT} + {I}_{DELTA} \\ = {I}_{INPUT} + ( {I}_{INPUT} - {I}_{BLUR} ) \\ = {I}_{INPUT} + ( {I}_{INPUT} - ( {I}_{INPUT} \cdot Gauss )\end{matrix} \qquad ( E \text{-} 5 )$$

In step S226, the correction target image Lw is taken as the input image I_{INPUT}, and the filtered image is obtained as the output image I_{OUTPUT}. Then, in step S227, the ringing in this filtered image is eliminated to generate a blur-corrected image Qw (the processing in step S227 is the same as that in step S78 in FIG. 18).

The use of the unsharp mask filter enhances edges in the input image (I_{INPUT}), and thus offers an image sharpening effect. If, however, the degree of blurring with which the blurred image (I_{BLUR}) is generated greatly differs from the actual amount of blur contained in the input image, it is not possible to obtain an adequate blur correction effect. For example, if the degree of blurring with which the blurred image is generated is larger than the actual amount of blur, the output image (I_{OUTPUT}) is extremely sharpened and appears unnatural. By contrast, if the degree of blurring with which the blurred image is generated is smaller than the actual amount of blur, the sharpening effect is excessively weak. In this correction method, as an unsharp filter, a Gaussian filter of which the degree of blurring is defined by a is used and, as the σ of the Gaussian filter, the σ′ corresponding to an image degradation function is used. This makes it possible to obtain an optimal sharpening effect, and thus to obtain a blur-corrected image from which blur has been satisfactorily eliminated. That is, it is possible to generate an image with apparently little blur at low calculation cost.

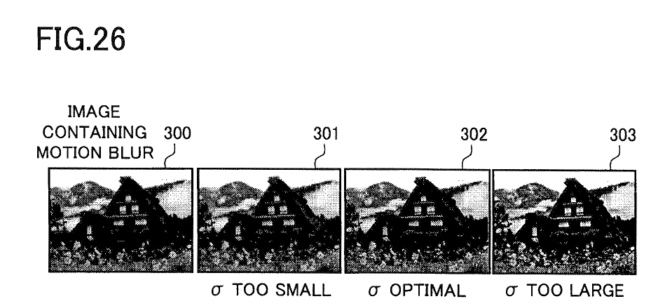

FIG. 26 shows, along with an image 300 containing motion blur as an example of the input image I_{INPUT}, an image 302 obtained by use of a Gaussian filter having an optimal σ (that is, the desired blur-corrected image), an image 301 obtained by use of a Gaussian filter having an excessively small σ, and an image 303 obtained by use of a Gaussian filter having an excessively large σ. It will be understood that an excessively small σ weakens the sharpening effect, and that an excessively large σ generates an extremely sharpened, unnatural image.

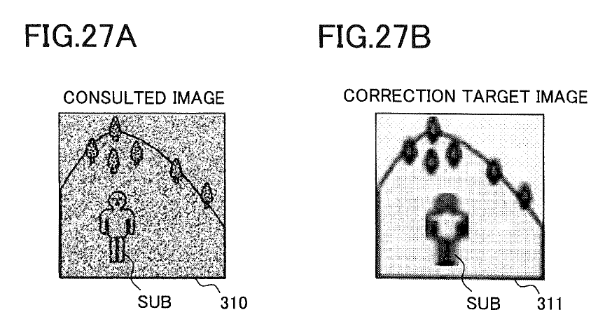

Fourth Correction Method: Next, a fourth correction method will be described. FIGS. 27A and 27B show an example of a consulted image Rw and a correction target image Lw, respectively, taken up in the description of the fourth correction method. The images 310 and 311 are an example of the consulted image Rw and the correction target image Lw respectively. The consulted image 310 and the correction target image 311 are obtained by shooting a scene in which a person SUB, as a foreground subject (a subject of interest), is standing against the background of a mountain, as a background subject.

Since a consulted image is an image based on a short-exposure image, it contains relatively much noise. Accordingly, as compared with the correction target image 311, the consulted image 310 shows sharp edges but is tainted with relatively much noise (corresponding to black spots in FIG. 27A). By contrast, as compared with the consulted image 310, the correction target image 311 contains less noise but shows the person SUB greatly blurred. FIGS. 27A and 27B assume that the person SUB keeps moving during the shooting of the consulted image 310 and the correction target image 311, and accordingly, as compared with the position of the person SUB in the consulted image 310, in the correction target image 311, the person SUB is located to the right, and in addition the person SUB in the correction target image 311 suffers subject motion blur.

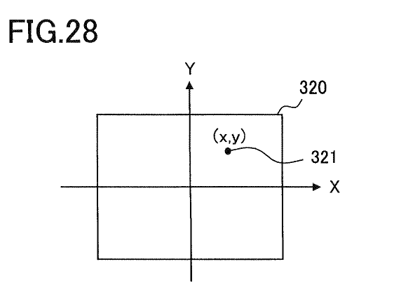

Moreover, as shown in FIG. 28, for the purpose of mapping an arbitrary two-dimensional image 320 on it, a two-dimensional coordinate system XY in a spatial domain is defined. The image 320 is, for example, a correction target image, a consulted image, a blur-corrected image, or any of the first to third intermediary images described later. The X and Y axes are axes running in the horizontal and vertical direction of the image 320. The two-dimensional image 320 is formed of a matrix of pixels of which a plurality are arrayed in both the horizontal and vertical directions, and the position of a pixel 321—any one of the pixels—on the two-dimensional image 320 is represented by (x, y). In the notation (x, y), x and y represent the X- and Y-direction coordinate values, respectively, of the pixel 321. In the two-dimensional coordinate system XY, as a pixel changes its position one pixel rightward, the X-direction coordinate value of the pixel increases by one; as a pixel changes its position one pixel upward, the Y-direction coordinate value of the pixel increases by one. Accordingly, in a case where the position of the pixel 321 is (x, y), the positions of the pixels adjacent to it to the right, left, top, and bottom are represented by (x+1, y), (x−1, y), (x, y+1), and (x, y−1), respectively.

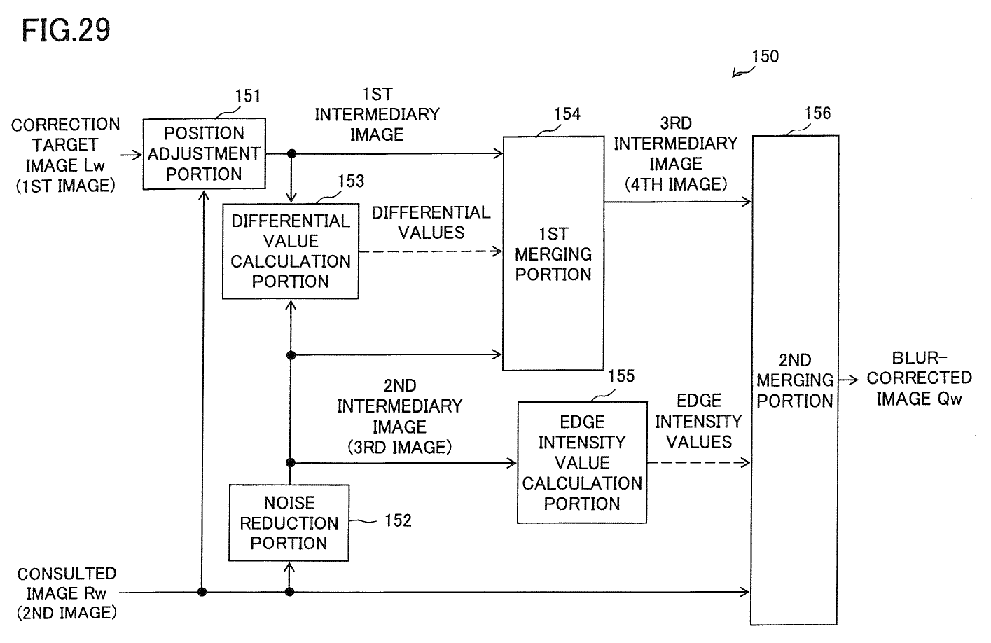

FIG. 29 is an internal block diagram of an image merging portion 150 provided within the blur correction processing portion 53 in FIG. 3 in a case where the fourth correction method is adopted. The image data of the consulted image Rw and the correction target image Lw is fed to the image merging portion 150. Image data represents the color and luminance of an image.

The image merging portion 150 is provided with: a position adjustment portion 151 that detects the displacement between the consulted image and the correction target image and adjusts their positions; a noise reduction portion 152 that reduces the noise contained in the consulted image; a differential value calculation portion 153 that finds the difference between the correction target image after position adjustment and the consulted image after noise reduction to calculate the differential values at the individual pixel positions; a first merging portion 154 that merges together the correction target image after position adjustment and the consulted image after noise reduction at merging ratios based on those differential values; an edge intensity value calculation portion 155 that extracts edges from the consulted image after noise reduction to calculate edge intensity values; and a second merging portion 156 that merges together the consulted image and the merged image generated by the first merging portion 154 at merging ratios based on the edge intensity values to thereby generate a blur-corrected image.

The operation of the individual blocks within the image merging portion 150 will now be described in detail. What is referred to simply as a “consulted image” below is a consulted image Rw that has not yet been undergone noise reduction processing by the noise reduction portion 152. The consulted image 310 shown as an example in FIG. 27A is a consulted image Rw that has not yet been undergone noise reduction processing by the noise reduction portion 152.

Based on the image data of a consulted image and a correction target image, the position adjustment portion 151 detects the displacement between the consulted image and the correction target image, and adjusts the positions of the consulted image and the correction target image in such a way as to cancel the displacement between the consulted image and the correction target image. The displacement detection and position adjustment by the position adjustment portion 151 can be achieved by representative point matching, block matching, a gradient method, or the like. Typically, for example, the method for position adjustment described in connection with the second embodiment can be used. In that case, position adjustment is performed with the consulted image taken as a datum image and the correction target image as a non-datum image. Accordingly, processing for correcting the displacement of the correction target image relative to the consulted image is performed on the correction target image. The correction target image after the displacement correction (in other words, the correction target image after position adjustment) is called the first intermediary image.

The noise reduction portion 152 applies noise reduction processing to the consulted image to reduce noise contained in the consulted image. The noise reduction processing by the noise reduction portion 152 can be achieved by any type of spatial filtering suitable for noise reduction. In the spatial filtering by the noise reduction portion 152, it is preferable to use a spatial filter that retains edges as much as possible; for example, it is preferable to adopt spatial filtering using a median filter.

Instead, the noise reduction processing by the noise reduction portion 152 may be achieved by any type of frequency filtering suitable for noise reduction. In a case where frequency filtering is used in the noise reduction portion 152, it is preferable to use a low-pass filter that, out of the spatial frequency components contained in the consulted image, passes those lower than a predetermined cut-off frequency and reduces those equal to or higher than the cut-off frequency. Incidentally, also by spatial filtering using a median filter or the like, out of the spatial frequency components contained in the consulted image, those of relatively low frequencies are left almost intact while those of relatively high frequencies are reduced. Thus, spatial filtering using a median filter or the like can be thought of as a kind of filtering by means of a low-pass filter.

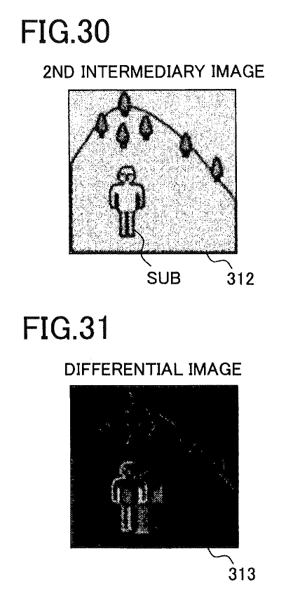

The consulted image after the noise reduction processing by the noise reduction portion 152 is called the second intermediary image (third image). FIG. 30 shows the second intermediary image 312 obtained by applying noise reduction processing to the consulted image 310 in FIG. 27A. As will be seen from a comparison between FIGS. 27A and 30, in the second intermediary image 312, whereas the noise contained in the consulted image 310 has been reduced, edges have become slightly less sharp than in the consulted image 310.

The differential value calculation portion 153 calculates, between the first and second intermediary images, the differential values at the individual pixel positions. The differential value at pixel position (x, y) is represented by DIF(x, y). The differential value DIF(x, y) is a value that represents the difference in luminance and/or color between the pixel at pixel position (x, y) in the first intermediary image and the pixel at pixel position (x, y) in the second intermediary image.

The differential value calculation portion 153 calculates the differential value DIF(x, y) according to, for example, formula (F-1) below. Here, P1_{Y}(x, y) represents the luminance value of the pixel at pixel position (x, y) in the first intermediary image, and P2_{Y}(x, y) represents the luminance value of the pixel at pixel position (x, y) in the second intermediary image.

DIF(x,y)=|P1_{Y}(x,y)−P2_{Y}(x,y)| (F-1)

The differential value DIF(x, y) may be calculated, instead of according to formula (F-1), by use of signal values in the RGB format, that is, according to formula (F-2) or (F-3) below. Here, P1_{R}(x, y), P1_{G}(x, y), and P1_{B}(x, y) represent the values of the R, G, and B signals, respectively, of the pixel at pixel position (x, y) in the first intermediary image; P2_{R}(x, y), P2_{G}(x, y), and P2_{B}(x, y) represent the values of the R, G, and B signals, respectively, of the pixel at pixel position (x, y) in the second intermediary image. The R, G, and B signals of a pixel are chrominance signals representing the intensity of red, green, and blue at that pixel.

DIF(x,y)=|P1_{R}(x,y)−P2_{R}(x,y)|+|P1_{G}(x,y)−P2_{G}(x,y)|+|P1_{B}(x,y)−P2_{B}(x,y)| (F-2)

DIF(x,y)=[{P1_{R}(x,y)−P2_{R}(x,y)}²+{P1_{G}(x,y)−P2_{G}(x,y)}²+{P1_{B}(x,y)−P2_{B}(x,y)}²]^{1/2} (F-3)

The above-described methods for calculating the differential value DIF(x, y) according to formula (F-1) and according to formula (F-2) or (F-3) are merely examples; the differential value DIF(x, y) may be found by any other method. For example, by use of signal values in the YUV format, the differential value DIF(x, y) may be calculated by the same method as when signal values in the RGB format are used. In that case, R, G, and B in formulae (F-2) and (F-3) are read as Y, U, and V respectively. Signals in the YUV format are composed of a luminance signal represented by Y and color difference signals represented by U and V.

FIG. 31 shows an example of a differential image in which the pixel signal values at the individual pixel positions equal the differential values DIF(x, y). The differential image 313 in FIG. 31 is a differential image based on the consulted image 310 and the correction target image 311 in FIGS. 27A and 27B. In the differential image 313, parts where the differential values DIF(x, y) are relatively large are shown white, and parts where the differential values DIF(x, y) are relatively small are shown black. As a result of the movement of the person SUB during the shooting of the consulted image 310 and the correction target image 311, the differential values DIF(x, y) are relatively large in the region of the movement of the person SUB in the differential image 313. Moreover, due to blur in the correction target image 311 resulting from motion blur (physical vibration such as camera shake), the differential values DIF(x, y) are large also near edges (contours of the person and the mountain).

The first merging portion 154 merges together the first and second intermediary images, and outputs the resulting merged image as a third intermediary image (fourth image). The merging here is achieved by weighted addition of the pixel signals of corresponding pixels between the first and second intermediary images. The mixing factors (in other words, merging ratios) at which the pixel signals of corresponding pixels are mixed by weighted addition can be determined based on the differential values DIF(x, y). The mixing factor determined by the first merging portion 154 with respect to pixel position (x, y) is represented by α(x, y).

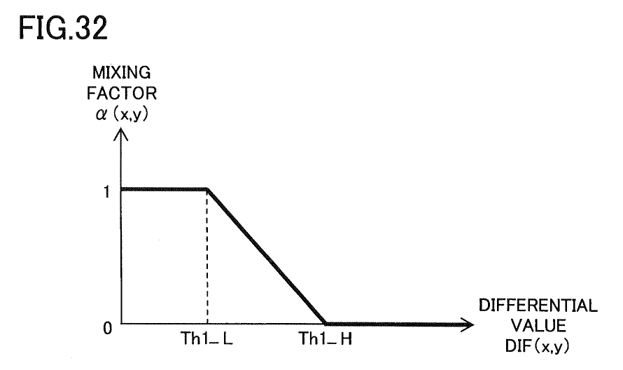

An example of the relationship between the differential value DIF(x, y) and the mixing factor α(x, y) is shown in FIG. 32. In a case where the example of relationship in FIG. 32 is adopted, the mixing factor α(x, y) is determined such that

if “DIF(x, y)<Th1_{—}L” is fulfilled, “α(x, y)=1”;

if “Th1_{—}L≦DIF(x, y)<Th1_{—}H” is fulfilled “α(x, y)=1−(DIF(x, y)−Th1_{—}L)/(Th1_{—}H−Th1_{—}L)”; and

if “Th1_{—}H≦DIF(x, y)” is fulfilled, “α(x, y)=0”.

Here, Th1_L and Th1_H are predetermined threshold values fulfilling “0<Th1_L<Th1_H”. In a case where the example of relationship in FIG. 32 is adopted, as a differential value DIF(x, y) increases from the threshold value Th1_L to the threshold value Th1_H, the corresponding mixing factor α(x, y) decreases linearly from 1 to 0. Instead, the mixing factor α(x, y) may be made to decrease non-linearly.

After determining based on the differential values DIF(x, y) at the individual pixel positions the mixing factors α(x, y) at the individual pixel positions, the first merging portion 154 mixes the pixel signals of corresponding pixels between the first and second intermediary images according to formula (F-4) below, and thereby generates the pixel signals of the third intermediary image.

P3(x,y)=α(x,y)×P1(x,y)+{1−α(x,y)}×P2(x,y) (F-4)

P1(x, y), P2(x, y), and P3(x, y) are pixel signals representing the luminance and color of the pixel at pixel position (x, y) in the first, second, and third intermediary images respectively, and these pixel signals are expressed, for example, in the RGB or YUV format. For example, in a case where the pixel signals P1(x, y) etc. are each composed of R, G, and B signals, the pixel signals P1(x, y) and P2(x, y) are mixed, with respect to each of the R, G, and B signals separately, to generate the pixel signal P3(x, y). The same applies in a case where the pixel signals P1(x, y) etc. are each composed of Y, U, and V signals.

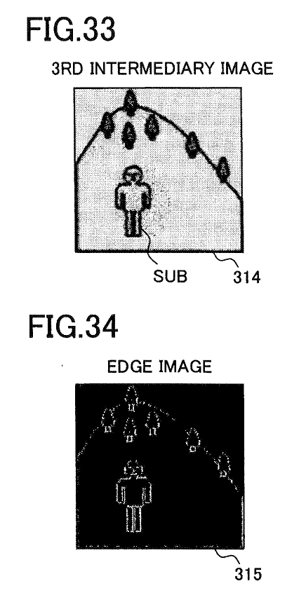

FIG. 33 shows an example of the third intermediary image obtained by the first merging portion 154. The third intermediary image 314 shown in FIG. 32 is a third intermediary image based on the consulted image 310 and the correction target image 311 in FIGS. 27A and 27B.

In the region of the movement of the person SUB, the differential values DIF(x, y) are relatively large as described above, and thus the degree of contribution (1−α(x, y)) of the second intermediary image 312 (see FIG. 30) to the third intermediary image 314 is relatively large. Consequently, the subject blur in the third intermediary image 314 is greatly reduced as compared with that in the correction target image 311 (see FIG. 27A). Also near edges, the differential values DIF(x, y) are large, and thus the above-mentioned degree of contribution (1−α(x, y)) is large. Consequently, the edge sharpness in the third intermediary image 314 is improved as compared with that in the correction target image 311. However, since edges in the second intermediary image 312 are slightly less sharp than those in the consulted image 310, edges in the third intermediary image 314 also are slightly less sharp than those in the consulted image 310.

On the other hand, a region where the differential values DIF(x, y) are relatively small is supposed to be a flat region with a small edge component. Accordingly, in a region where the differential values DIF(x, y) are relatively small, as described above, the degree of contribution α(x, y) of the first intermediary image, which contains less noise, is made relatively large. This helps reduce noise in the third intermediary image. Incidentally, since the second intermediary image is generated through noise reduction processing, noise is hardly noticeable even in a region where the degree of contribution (1−α(x, y)) of the second intermediary image to the third intermediary image is relatively large.

As described above, edges in the third intermediary image are slightly less sharp as compared with those in the consulted image. This unsharpness is improved by the edge intensity value calculation portion 155 and the second merging portion 156.

The edge intensity value calculation portion 155 performs edge extraction processing on the second intermediary image, and calculates the edge intensity values at the individual pixel positions. The edge intensity value at pixel position (x, y) is represented by E(x, y). The edge intensity value E(x, y) is an index indicating the amount of variation among the pixel signals within a small block centered around pixel position (x, y) in the second intermediary image, and the larger the amount of variation, the larger the edge intensity value E(x, y).

The edge intensity value E(x, y) is found, for example, according to formula (F-5) below. As described above, P2_{Y}(x, y) represents the luminance value of the pixel at pixel position (x, y) in the second intermediary image. Fx(i, j) and Fy(i, j) represent the filter coefficients of an edge extraction filter for extracting edges in the horizontal and vertical directions respectively. As the edge extraction filter, any spatial filter suitable for edge extraction can be used; for example, it is possible to use a Prewitt filter, a Sobel filter, a differentiation filter, or a Lalacian filter.

$$E ( x , y ) = \vert {\sum }_{i = - 1}^{1} {\sum }_{j = - 1}^{1} Fx ( i , j ) \cdot P {2}_{Y} ( x + i , y + j ) \vert + \vert {\sum }_{i = - 1}^{1} {\sum }_{j = - 1}^{1} Fy ( i , j ) \cdot P {2}_{Y} ( x + i , y + j ) \vert \qquad ( F \text{-} 5 )$$

For example, in a case where a Prewitt filter is used, Fx(i, j) in (F-5) is substituted by “Fx(−1, −1)=Fx(−1, 0)=Fx(−1, 1)=−1”, “Fx(0, −1)=Fx(0, 0)=Fx(0, 1)=0”, and “Fx(1, −1)=Fx(1, 0)=Fx(1, 1)=1”, and Fy(i, j) in formula (F-5) is substituted by “Fy(−1, −1)=Fy(0, −1)=Fy(1, −1)=−1”, “Fy(−1, 0)=Fy(0, 0)=Fy(1, 0)=0”, and “F(−1, 1)=Fy(0, 1)=Fy(1, 1)=1”. Needless to say, these filter coefficients are merely examples, and the edge extraction filter for calculating the edge intensity values E(x, y) can be modified in many ways. Although formula (F-5) uses an edge extraction filter having a filter size of 3×3, the edge extraction filter may have any filter size other than 3×3.

FIG. 34 shows an example of an edge image in which the pixel signal values at the individual pixel positions equal the edge intensity values E(x, y). The edge image 315 in FIG. 34 is an edge image based on the consulted image 310 and the correction target image 311 in FIGS. 27A and 27B. In the edge image 315, parts where the edge intensity values E(x, y) are relatively large are shown white, and parts where the edge intensity values E(x, y) are relatively small are shown black. The edge intensity values E(x, y) are obtained by extracting edges from the second intermediary image 312 obtained by reducing noise in the consulted image 310, in which edges are sharp. In this way, edges are separated from noise, and thus the edge intensity values E(x, y) identify the positions of edges as recognized after edges of the subject have been definitely distinguished from noise.

The second merging portion 156 merges together the third intermediary image and the consulted image, and outputs the resulting merged image as a blur-corrected image (Qw). The merging here is achieved by weighted addition of the pixel signals of corresponding pixels between the third intermediary image and the consulted image. The mixing factors (in other words, merging ratios) at which the pixel signals of corresponding pixels are mixed by weighted addition can be determined based on the edge intensity values E(x, y). The mixing factor determined by the second merging portion 156 with respect to pixel position (x, y) is represented by β(x, y).

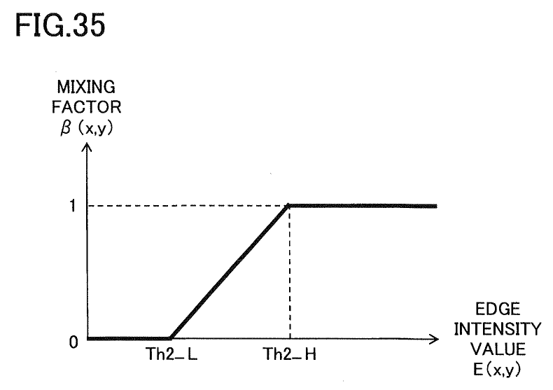

An example of the relationship between the edge intensity value E(x, y) and the mixing factor β(x, y) is shown in FIG. 35. In a case where the example of relationship in FIG. 35 is adopted, the mixing factor β(x, y) is determined such that

if “E(x, y)<Th2_{—}L” is fulfilled, “β(x, y)=0”;

if “Th2_{—}L≦E(x, y)<Th2_{—}H” is fulfilled “β(x, y)=(E(x, y)−Th2_{—}L)/(Th2_{—}H−Th2_{—}L)”; and

if “Th2_{—}H≦E(x, y)” is fulfilled, “β(x, y)=1”.

Here, Th2_L and Th2_H are predetermined threshold values fulfilling “0<Th2_L<Th2_H”. In a case where the example of relationship in FIG. 35 is adopted, as an edge intensity value E(x, y) increases from the threshold value Th2_L to the threshold value Th2_H, the corresponding mixing factor β(x, y) increases linearly from 0 to 1. Instead, the mixing factor β(x, y) may be made to increase non-linearly.

After determining based on the edge intensity values E(x, y) at the individual pixel positions the mixing factors β(x, y) at the individual pixel positions, the second merging portion 156 mixes the pixel signals of corresponding pixels between the third intermediary image and the consulted image according to formula (F-6) below, and thereby generates the pixel signals of the blur-corrected image.

P_{OUT}(x,y)=β(x,y)×P_{IN}_{_{—}}_{SH}(x, y)+{1−β(x,y)}×P3(x,y) (F-6)

P_{OUT}(x, y), P_{IN}_{_{—}}_{SH}(x, y), and P3(x, y) are pixel signals representing the luminance and color of the pixel at pixel position (x, y) in the blur-corrected image, the consulted image, and the third intermediary image respectively, and these pixel signals are expressed, for example, in the RGB or YUV format. For example, in a case where the pixel signals P3(x, y) etc. are each composed of R, G, and B signals, the pixel signals P_{IN}_{_{—}}_{SH}(x, y) and P3(x, y) are mixed, with respect to each of the R, G, and B signals separately, to generate the pixel signal P_{OUT}(x, y). The same applies in a case where the pixel signals P3(x, y) etc. are each composed of Y, U, and V signals.

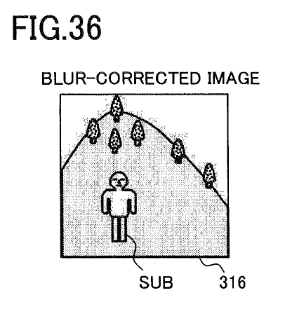

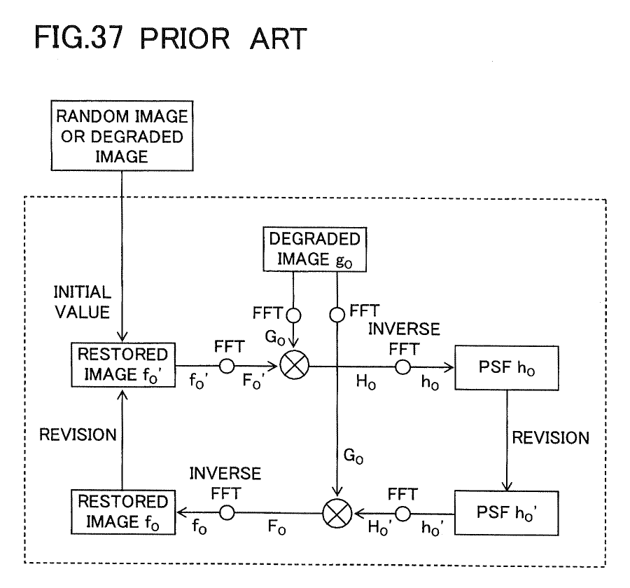

FIG. 36 shows a blur-corrected image 316 as an example of the blur-corrected image Qw obtained by the second merging portion 156. The blur-corrected image 316 is a blur-corrected image based on the consulted image 310 and the correction target image 311 in FIGS. 27A and 27B. In edge parts, the degree of contribution β(x, y) of the consulted image 310 to the blur-corrected image 316 is large; thus, in the blur-corrected image 316, the slight unsharpness of edges in the third intermediary image 314 (see FIG. 33) has been improved, so that edges appear sharp. By contrast, in non-edge parts, the degree of contribution (1−β(x, y)) of the third intermediary image 314 to the blur-corrected image 316 is large; thus, in the blur-corrected image 316, the noise contained in the consulted image 310 is reflected to a lesser degree. Since noise is visually noticeable in particular in non-edge parts (flat parts), adjustment of merging ratios by means of mixing factors β(x, y) as described above is effective.

As described above, with the fourth correction method, by merging a correction target image (more specifically, a correction target image after position adjustment (that is, a first intermediary image)) and a consulted image after noise reduction (that is, a second intermediary image) together by use of differential values obtained from them, it is possible to generate a third intermediary image in which the blur in the correction target image and the noise in the consulted image have been reduced. Thereafter, by merging the third intermediary image and the consulted image together by use of edge intensity values obtained from the consulted image after noise reduction (that is the second intermediary image), it is possible to make the resulting blur-corrected image reflect the sharp edges in the consulted image but reflect less of the noise in the consulted image. Thus, the blur-corrected image has little blur and little noise.

To detect edges and noise while definitely distinguishing them, and to satisfactorily prevent the blur-corrected image from being tainted with the noise in the consulted image, it is preferable, as described above, to derive edge intensity values from the consulted image after noise reduction (that is, the second intermediary image); it is, however, also possible to derive edge intensity values from the consulted image before noise reduction (that is, for example, the consulted image 310 in FIG. 27A). In that case, with P2_{Y}(x, y) in formula (F-5) substituted by the luminance value of the pixel at pixel position (x, y) in the consulted image before noise reduction, the edge intensity value E(x, y) is calculated according to formula (F-5).

### Modifications and Variations

The specific values given in the description above are merely examples, which, needless to say, may be modified to any other values. In connection with the embodiments described above, modified examples or supplementary explanations applicable to them will be given below in Notes 1 and 2. Unless inconsistent, any part of the contents of these notes may be combined with any other.

Note 1: The image shooting apparatus 1 of FIG. 1 can be realized with hardware, or with a combination of hardware and software. In particular, all or part of the functions of the individual blocks shown in FIGS. 3 and 29 can be realized with hardware, with software, or with a combination of hardware and software. In a case where the image shooting apparatus 1 is built with software, any block diagram showing the blocks realized with software serves as a functional block diagram of those blocks.

All or part of the calculation processing executed by the blocks shown in FIGS. 3 and 29 may be prepared in the form of a software program so that, when this software program is executed on a program executing apparatus (e.g. a computer), all or part of those functions are realized.

Note 2: The following interpretations are possible. In the first or second embodiment, the part including the shooting control portion 51 and the correction control portion 52 shown in FIG. 3 functions as a control portion that controls whether or not to execute blur correction processing or the number of short-exposure images to be shot. In the third embodiment, the control portion that controls whether or not to execute blur correction processing includes the correction control portion 52, and may further include the shooting control portion 51. In the third embodiment, the correction control portion 52 is provided as a blur estimation portion that estimates the degree of blur in a short-exposure image. In a case where the first correction method described in connection with the fourth embodiment is used as the method for blur correction processing, the blur correction processing portion 53 in FIG. 3 includes an image degradation function derivation portion that finds an image degradation function (specifically, a PSF) of a correction target image.

What is claimed is:

1. An image shooting apparatus comprising:
an image-sensing portion adapted to acquire an image by shooting;
a blur correction processing portion adapted to correct blur in a first image obtained by shooting based on the first image and a second image shot with an exposure time shorter than an exposure time of the first image; and
a control portion adapted to control whether or not to make the blur correction processing portion execute blur correction processing.

2. The image shooting apparatus according to claim 1,
wherein the control portion comprises a blur estimation portion adapted to estimate a degree of blur in the second image, and controls, based on a result of estimation by the blur estimation portion, whether or not to make the blur correction processing portion execute blur correction processing.

3. The image shooting apparatus according to claim 2,
wherein the blur estimation portion estimates the degree of blur in the second image based on a result of comparison between edge intensity of the first image and edge intensity of the second image.

4. The image shooting apparatus according to claim 3, wherein
sensitivity for adjusting brightness of a shot image differs between during shooting of the first image and during shooting of the second image, and
the blur estimation portion executes the comparison through processing involving reducing a difference in edge intensity between the first and second images resulting from a difference in sensitivity between during shooting of the first image and during shooting of the second image.

5. The image shooting apparatus according to claim 2,
wherein the blur estimation portion estimates the degree of blur in the second image based on an amount of displacement between the first and second images.

6. The image shooting apparatus according to claim 2,
wherein the blur estimation portion estimates the degree of blur in the second image based on an estimated image degradation function of the first image as found by use of the first and second images.

7. The image shooting apparatus according to claim 6,
wherein the blur estimation portion refers to values of individual elements of the estimated image degradation function as expressed in a form of a matrix, extracts, out of the values thus referred to, values falling outside a prescribed value range, and estimates the degree of blur in the second image based on a sum value of the values thus extracted.

8. An image shooting apparatus comprising:
an image-sensing portion adapted to acquire an image by shooting;
a blur correction processing portion adapted to correct blur in a first image obtained by shooting based on the first image and one or more second images shot with an exposure time shorter than an exposure time of the first image; and
a control portion adapted to control, based on a shooting parameter of the first image, whether or not to make the blur correction processing portion execute blur correction processing or a number of second images to be used in blur correction processing.

9. The image shooting apparatus according to claim 8,
wherein the control portion comprises:
a second-image shooting control portion adapted to judge whether or not it is practicable to shoot the second image based on the shooting parameter of the first image and control the image-sensing portion accordingly; and
a correction control portion adapted to control, according to a result of judgment of whether or not it is practicable to shoot the second image, whether or not to make the blur correction processing portion execute blur correction processing.

10. The image shooting apparatus according to claim 8, wherein
the control portion comprises a second-image shooting control portion adapted to determine, based on the shooting parameter of the first image, the number of second images to be used in blur correction processing by the blur correction processing portion and control the image-sensing portion so as to shoot the thus determined number of second images,
the second-image shooting control portion determines the number of second images to be one or plural, and
when the number of second images is plural, the blur correction processing portion additively merges together the plural number of second images to generate one merged image, and corrects blur in the first image based on the first image and the merged image.

11. The image shooting apparatus according to claim 8,
wherein the shooting parameter of the first image includes focal length, exposure time, and sensitivity for adjusting brightness of an image during shooting of the first image.

12. The image shooting apparatus according to claim 9,
wherein the second-image shooting control portion sets a shooting parameter of the second image based on the shooting parameter of the first image.

13. The image shooting apparatus according to claim 1,
wherein the blur correction processing portion handles an image based on the first image as a degraded image and an image based on the second image as an initial restored image, and corrects blur in the first image by use of Fourier iteration.

14. The image shooting apparatus according to claim 1, wherein
the blur correction processing portion comprises an image degradation function derivation portion adapted to find an image degradation function representing blur in the entire first image, and corrects blur in the first image based on the image degradation function, and
the image degradation function derivation portion definitively finds the image degradation function through processing involving
preliminarily finding the image degradation function in a frequency domain from a first function obtained by converting an image based on the first image into a frequency domain and a second function obtained by converting an image based on the second image into a frequency domain, and
revising, by use of a predetermined restricting condition, a function obtained by converting the thus found image degradation function in a frequency domain into a spatial domain.

15. The image shooting apparatus according to claim 1,
wherein the blur correction processing portion merges together the first image, the second image, and a third image obtained by reducing noise in the second image, to thereby generate a blur-corrected image in which blur in the first image has been corrected.

16. The image shooting apparatus according to claim 15,
wherein the blur correction processing portion first merges together the first and third images to generate a fourth image, and then merges together the second and fourth images to generate the blur-corrected image.

17. The image shooting apparatus according to claim 16, wherein
a merging ratio at which the first and third images are merged together is set based on a difference between the first and third images, and
a merging ratio at which the second and fourth images are merged together is set based on an edge contained in the third image.

18. The image shooting apparatus according to claim 8,
wherein the blur correction processing portion handles an image based on the first image as a degraded image and an image based on the second image as an initial restored image, and corrects blur in the first image by use of Fourier iteration.

19. The image shooting apparatus according to claim 8, wherein
the blur correction processing portion comprises an image degradation function derivation portion adapted to find an image degradation function representing blur in the entire first image, and corrects blur in the first image based on the image degradation function, and
the image degradation function derivation portion definitively finds the image degradation function through processing involving
preliminarily finding the image degradation function in a frequency domain from a first function obtained by converting an image based on the first image into a frequency domain and a second function obtained by converting an image based on the second image into a frequency domain, and
revising, by use of a predetermined restricting condition, a function obtained by converting the thus found image degradation function in a frequency domain into a spatial domain.

20. The image shooting apparatus according to claim 8,
wherein the blur correction processing portion merges together the first image, the second image, and a third image obtained by reducing noise in the second image, to thereby generate a blur-corrected image in which blur in the first image has been corrected.

21. The image shooting apparatus according to claim 20,
wherein the blur correction processing portion first merges together the first and third images to generate a fourth image, and then merges together the second and fourth images to generate the blur-corrected image.

22. The image shooting apparatus according to claim 21, wherein
a merging ratio at which the first and third images are merged together is set based on a difference between the first and third images, and
a merging ratio at which the second and fourth images are merged together is set based on an edge contained in the third image.

23. A blur correction method comprising:
a blur correction processing step of correcting blur in a first image obtained by shooting based on the first image and one or more second images shot with an exposure time shorter than an exposure time of the first image; and
a controlling step of controlling whether or not to make the blur correction processing step execute blur correction processing.

24. The blur correction method according to claim 23,
wherein the controlling step comprises a blur estimation step of estimating a degree of blur in the second image so that, based on a result of the estimation, whether or not to make the blur correction processing step execute blur correction processing is controlled.

25. A blur correction method comprising:
a blur correction processing step of correcting blur in a first image obtained by shooting based on the first image and one or more second images shot with an exposure time shorter than an exposure time of the first image; and
a controlling step of controlling, based on a shooting parameter of the first image, whether or not to make the blur correction processing step execute blur correction processing or a number of second images to be used in blur correction processing.
